(19) United States
(12) Patent Application Publication
(10) Pub. No.: US 2026/0194662 A1
(43) Pub. Date: Jul. 9, 2026

(54) Assistance Data for Determining a Position

(71) Applicant: Telefonaktiebolaget LM Ericsson (publ), Stockholm (SE)

(72) Inventors: Fredrik Gunnarsson, Linköping (SE); Ritesh Shreevastav, Upplands Väsby (SE)

(21) Appl. No.: 19/136,568

(22) PCT Filed: Feb. 15, 2024
(86) PCT No.: PCT/SE2024/050151

§ 371 Date: Jun. 6, 2025

Related U.S. Application Data
(60) Provisional application No. 63/446,391, filed on Feb. 17, 2023.

(51) Int. Cl. G01S 19/07; G01S 19/25

(52) U.S. Cl. CPC G01S 19/07; G01S 19/258

(57) ABSTRACT

According to an aspect, there is provided a method performed by a user equipment (UE) that comprises the UE receiving (510; 701) first assistance data for a first Global Navigation Satellite System (GNSS) from a network node, and receiving (520; 703) second assistance data for a second GNSS from the network node The first assistance data comprises tropospheric delay correction data, and the second assistance data does not include tropospheric delay correction data.

### TECHNICAL FIELD

This disclosure relates to the provision of assistance data for use by a user equipment (UE) in determining a position of the UE using signals from a Global Navigation Satellite System (GNSS).

### BACKGROUND

Positioning in 4th Generation (4G)/Long Term Evolution (LTE)/Evolved Packet Core (EPC) and 5th Generation (5G)/New Radio (NR)/5G Core (5GC) is supported by the architecture in FIG. 1, in which direct interactions between a User Equipment (UE) 100 and a location server 130 are via the LTE Positioning Protocol (LPP) 151. Moreover, there are also interactions between the location server 130 and a serving radio base station 110 via the LPPa protocol 152, to some extent supported by interactions between the radio base station 110 and the UE 100 via the Radio Resource Control (RRC) protocol 150. The radio base station 110 interacts with a mobility network entity 120 via a first interface protocol 153, and the mobility network entity 120 interacts with the location server 130 via a second interface protocol 154. In some applications, the location server interacts with a Global Navigation Satellite System (GNSS) correction data provider 140 via a third interface protocol 155.

The location server 130 is the entity in the network architecture that is responsible for collecting information/measurements from the UE 100 and/or radio base station 110 (or more generally the radio access network (RAN)), and calculating the position of the UE 100 from that information/measurements. Generally, the location server 130 provides location services (LCS).

In 4G/LTE/EPC and 5G/NR/5GC, the servers/nodes/functions/interfaces/protocols mentioned above are named as shown in Table 1 below:

TABLE 1

| Generic name | Name in 4G/LTE/EPC | Name in 5G/NR/5GC |
|---|---|---|
| Location server (130) | Evolved Serving Mobile | Location Management |
| | Location Center (E- | Function (LMF) or |
| | SMLC) or SLP | SLP |
| Radio base station | eNodeB | gNodeB |
| (110) | | |
| Mobility network | Mobility Management | Access and Mobility |
| entity (120) | Entity (MME) | Management Function |
| | | (AMF) |
| First interface (153) | S1-MME | N2 |
| Second interface (154) | SLs | NL1 |

In both cases, the location server can also be interacting with the UE directly over user plane (UP) communications carrying LPP 151 with signalling defined by the Open Mobile Alliance (OMA) Secure UserPlane Location (SUPL), or some other user plane signalling. In the case of SUPL, the location server is denoted SUPL Location Platform (SLP) and the UE is denoted SUPL Enabled Terminal (SET).

There are several options for the interface, signalling and message handling over the third interface 155 between the location server 130 and a correction data provider 140. One option is message handling defined by the Radio Technical Commission for Maritime (RTCM) special committee 104 with the user plane signalling protocol Networked Transport of RTCM via Internet Protocol (NTRIP). RTCM SC 104 initially defined differential corrections to GNSS.

The 3rd Generation Partnership Project (3GPP) Release (Rel.) 9 introduced support for assisted Global Navigation Satellite System (GNSS), and the scope of the assistance data has been refined over the releases. In Rel. 15, support for Real Time Kinematics (RTK) GNSS was introduced. The assistance data is generated based on observations from one or more reference stations, where a reference station is a node with known position and known antenna configuration, and a GNSS receiver capable of measuring signals from one or more satellite systems, where the satellite systems comprise one or more satellites, and each satellite transmits one or more signals. Typically, the GNSS RTK assistance data is provided by a separate function, correction data provider or Network RTK (NRTK) server (140).

GNSS represents a generic system, with examples such as Global Positioning System (GPS), Global Navigation Satellite System (GLONASS), GALILEO, Quasi-Zenith Satellite System (QZSS) and BeiDou. These systems-individually referred to as respective “GNSS constellations”—are based on a number of GNSS satellites, each transmitting GNSS signals associated to a specific GNSS signal identity. The satellites follow tailored orbits around the globe.

The one or more signals transmitted by each satellite are transmitted associated to its clock timing, propagating through the atmosphere to the UE. The estimated range (distance) between the satellite and the UE based on the received signal is subject to different error contributions:
Satellite orbit errors, where the satellite is not exactly following its predicted and announced orbit;
Satellite clock errors, where the provided clock information to the UE is subject to an error;
Satellite signal bias, where the different signals from the same satellite are not transmitted exactly simultaneously;
Atmospheric ionospheric error, where the ionosphere interacts with the signals and delays them;
Atmospheric tropospheric delays, where particles and water vapor in the troposphere delays the signal (this is illustrated in FIG. 2 where 200 represents the troposphere, and a UE 100 and two satellites 160 are also shown);
Device (UE) errors, such as device clock error, signal multipath and signal measurement errors.

FIG. 3 illustrates the different 4G/LTE/EPC and 5G/NR/5GC entities in the more complete and common architecture 300. The nodes and functions generally on the left hand side of FIG. 3 relate to the 4G/LTE/EPC architecture, and the nodes and functions generally on the right hand side of FIG. 3 relate to the 5G/NR/5GC architecture. The 5G/NR/5GC architecture includes a 5G Gateway Mobile Location Center (GMLC).

5G positioning methods based on 5G signals is realised with downlink positioning reference signals, associated to a specific radio resource, which may be transmitted using a radio beam with directivity. Each positioning reference signal is associated to an identifier. One or more such signals are transmitted from a specific transmission point associated to a radio base station 110.

Positioning methods rely on measurements, and several positioning methods rely on measurements of GNSS signals, WiFi signals, Bluetooth signals, beacon signals, radio access technology (RAT)-dependent signals, etc. by the UE whose position is to be determined. Such measurements are subject to errors or feared events, and a subset of such errors or feared events are due to the local environment of the UE.

Tropospheric delay corrections are provided over a spatial grid, where each grid is associated to tropospheric and ionospheric delay corrections.

The following is found in 3GPP TS 37.355 v17.3.0, which relates to the LPP:

### GNSS-SSR-GriddedCorrection

The IE GNSS-SSR-GriddedCorrection is used by the location server to provide troposphere delay correction, together with the residual part of the STEC corrections and integrity information.

The parameters provided in IE GNSS-SSR-GriddedCorrection-except for SSR-GriddedCorrectionIntegrityParameters and TropoDelayIntegrityErrorBounds—are used as specified for Compact SSR Gridded Correction Message (e.g., message type 4073,9) in and apply to all GNSSs.

-- ASN1START
GNSS-SSR-GriddedCorrection-r16 ::= SEQUENCE {

| epochTime-r16 | GNSS-SystemTime, | |
|---|---|---|
| ssrUpdateInterval-r16 | INTEGER (0..15), | |
| iod-ssr-r16 | INTEGER (0..15), | |
| troposphericDelayQualityIndicator-r16 | BIT STRING (SIZE(6)) | OPTIONAL, -- Cond |

Tropo

| | |
|---|---|
| correctionPointSetID-r16 | INTEGER (0..16383), |
| gridList-r16 | GridList-r16, |

```
  ...,
  [[
  ssr-GriddedCorrectionIntegrityParameters-r17
```

SSR-GriddedCorrectionIntegrityParameters-r17

OPTIONAL -- Need OR

]]
}
GridList-r16 ::= SEQUENCE (SIZE(1..64)) OF GridElement-r16
GridElement-r16 ::= SEQUENCE {

| | |
|---|---|
| tropospericDelayCorrection-r16 TropospericDelayCorrection-r16 | OPTIONAL, -- Need ON |
| stec-ResidualSatList-r16 STEC-ResidualSatList-r16 | OPTIONAL, -- Need ON |

```
  ...
}
TropospericDelayCorrection-r16 ::= SEQUENCE {
  tropoHydroStaticVerticalDelay-r16 INTEGER (−256..255),
  tropoWetVerticalDelay-r16 INTEGER (−128..127),
  ...,
  [[
  tropoDelayIntegrityErrorBounds-r17 TropoDelayIntegrityErrorBounds-r17
```

OPTIONAL -- Cond Integrity1

```
  ]]
}
STEC-ResidualSatList-r16 ::= SEQUENCE (SIZE(1..64)) OF STEC-ResidualSatElement-r16
STEC-ResidualSatElement-r16 ::= SEQUENCE {
  svID-r16 SV-ID,
  stecResidualCorrection-r16 CHOICE {
                b7-r16 INTEGER (−64..63),
                b16-r16 INTEGER (−32768..32767)
  },
  ...
}
SSR-GriddedCorrectionIntegrityParameters-r17 ::= SEQUENCE {
```

| probOnsetTroposphereFault-r17 | INTEGER (0..255), | |
|---|---|---|
| meanTroposphereFaultDuration-r17 | INTEGER (1..256), | |
| troposphereRangeErrorCorrelationTime-r17 | INTEGER (1..255) | OPTIONAL, -- Need OR |
| troposphereRangeRateErrorCorrelationTime-r17 | INTEGER (1..255) | OPTIONAL, -- Cond |

Integrity2
...
}
TropoDelayIntegrityErrorBounds-r17 ::= SEQUENCE {

| | |
|---|---|
| meanTroposphereVerticalHydroStaticDelay-r17 | INTEGER (0..255), |
| stdDevTroposphereVerticalHydroStaticDelay-r17 | INTEGER (0..255), |
| meanTroposphereVerticalWetDelay-r17 | INTEGER (0..255), |
| stdDevTroposphereVerticalWetDelay-r17 | INTEGER (0..255), |
| meanTroposphereVerticalHydroStaticDelayRate-r17 | INTEGER (0..255), |
| stdDevTroposphereVerticalHydroStaticDelayRate-r17 | INTEGER (0..255), |
| meanTroposphereVerticalWetDelayRate-r17 | INTEGER (0..255), |
| stdDevTroposphereVerticalWetDelayRate-r17 | INTEGER (0..255), |

...
}
-- ASN1STOP

| Conditional presence | Explanation |
|---|---|
| Tropo | The field is mandatory present if tropospericDelayCorrection is included in gridList. |
| | Otherwise it is not present. |
| Integrity1 | The field is mandatory present if SSR-GriddedCorrectionIntegrityParameters is present; |
| | otherwise it is not present. |
| Integrity2 | The field is mandatory present if troposphereRangeErrorCorrelation Time is present; |
| | otherwise it is not present. |

GNSS-SSR-GriddedCorrection field descriptions
epochTime
This field specifies the epoch time of the gridded correction data. The gnss-TimeID in GNSS-System Time shall be the
same as the GNSS-ID in IE GNSS-GenericAssistDataElement.
ssrUpdateinterval
This field specifies the SSR Update Interval. The SSR Update Intervals for all SSR parameters start at time 00:00:00
of the GPS time scale. A change of the SSR Update Interval during the transmission of SSR data should ensure
consistent data for a target device. See table Value of ssrUpdateInterval to SSR Update Interval relation in IE
GNSS-SSR-OrbitCorrections.
iod-ssr
This field specifies the Issue of Data number for the SSR data. A change of iod-ssr is used to indicate a change in the
SSR generating configuration.
troposphericDelayQualityindicator
This field specifies the quality indicator of the tropospheric delay. The troposphere quality indicator is represented by a
combination of CLASS and VALUE. The 3 MSB define the CLASS with a range of 0-7 and the 3 LSB define the
VALUE with a range of 0-7. The troposphere quality indicator is computed by:
$SSR Tropospher e Quality [ mm ] \leq {3}^{CLASS} ( 1 + \frac{VALUE}{4} ) - 1 [ mm ]$
See Table ′Relationship between SSR troposphere quality and URA indicator and physical quantity′ below.
correctionPointSetID
This field provides the ID of the GNSS-SSR-CorrectionPoints set. The GNSS-SSR-GriddedCorrection are valid for the
correction points provided in IE GNSS-SSR-CorrectionPoints with the same correctionPointSetID.
gridList
This field provides the troposphere delay correction together with the residual part of the STEC corrections for up to
64 correction points defined in IE GNSS-SSR-CorrectionPoints.
If the IE GNSS-SSR-CorrectionPoints, which belongs to the correctionPointSetID, includes the listOfCorrectionPoints,
the gridList includes the same number of entries, and listed in the same order, as in the listOfCorrectionPoints.
If the IE GNSS-SSR-CorrectionPoints, which belongs to this correctionPointSetID, includes the
arrayOfCorrectionPoints the gridList includes the same number of entries, and listed in the same order, as defined by
the enabled bits in the bitmaskOfGrids.
tropoHydroStaticVerticalDelay
This field specifies the variation in the hydro static troposphere vertical delay relative to nominal value. The target
device should add the constant nominal value of 2.3 m to calculate the tropospheric hydro-static vertical delay.
Scale factor 0.004 m; range ±1.02 m.
tropoWetVerticalDelay
This field specifies the variation in the wet troposphere vertical delay relative to nominal value. The target device
should add the constant value of 0.252 m to calculate the tropospheric wet (non hydro-static) vertical delay.
Scale factor 0.004 m; range ±0.508 m.
svID
This field specifies the GNSS satellite for which the STEC residual corrections are provided.
stecResidualCorrection
This field specifies the STEC residual correction.
Scale factor 0.04 TECU; range ±2.52 TECU (b7) or ±1310.68 TECU (b16).
probOnsetTroposphereFault
This field specifies the Probability of Onset of Troposphere Fault per Time Unit which is the probability of occurrence
of troposphere error to exceed the residual error bound for more than the Time to Alert (TTA) This field specifies the
onset probability that the residual range or range rate error exceeds a bound created using the minimum allowed
inflation factor Kₘᵢₙ, and bounding parameters as mean + Kₘᵢₙ * stdDev where Kₘᵢₙ = normInv(irMaximum / 2) and
irMaximum as provided in IE GNSS-Integrity-ServiceParameters.
The probability is calculated by P = 10^{-0.04n} [hour⁻¹] where n is the value of probOnsetTroposphereFault and the
range is 10^{-10.2} to 1 per hour.
meanTroposphereFaultDuration
This field specifies the Mean Troposphere Fault Duration which is the mean duration between when a troposphere
integrity violation occurs, and the user is alerted through GNSS-Integrity-ServiceAlert (or the integrity violation is over).
Scale factor 1 s; range 1-256 s.
troposphereRangeErrorCorrelationTime
This field specifies the Troposphere Range Error Correlation Time which is the upper bound of the correlation time of
the troposphere residual range error.
The time is calculated using:
$t = \{ \begin{matrix}10 i , & i \leq 180 \\ 1800 + 100 ( i - 180 ) , & 180 < i \leq 234 \\ 7200 + 1000 ( i - 234 ) , & i > 234\end{matrix} [ s ]$
Range is 1-28,200 s.
GNSS-SSR-GriddedCorrection field descriptions
troposphereRangeRateErrorCorrelationTime
This field specifies the Troposphere Range Rate Error Correlation Time which is the upper bound of the correlation
time of the troposphere residual range rate error.
The time is calculated using:
$t = \{ \begin{matrix}10 i , & i \leq 180 \\ 1800 + 100 ( i - 180 ) , & 180 < i \leq 234 \\ 7200 + 1000 ( i - 234 ) , & i > 234\end{matrix} [ s ]$
Range is 1-28,200 s.
meanTroposphereVerticalHydroStaticDelay
This field specifies the Mean Troposphere Vertical Hydro Static Delay Error bound which is the mean value for an
overbounding model that bounds the residual troposphere error in the vertical hydro static delay component.
The bound is mean TroposphereVerticalHydroStaticDelay + K * stdDevTroposphereVerticalHydro StaticDelay and shall
be so that the probability of it to be exceeded shall be lower than IRallocation for irMinimum < IRallocation <
irMaximum, where K = normInv(IRallocation / 2) and irMinimum, irMaximum as provided in IE GNSS-Integrity-
ServiceParameters.
This IRallocation is a fraction of the Target Integrity Risk that represents the integrity risk budget available.
Scale factor 0.005 m; range 0-1.275 m.
stdDevTroposphereVerticalHydroStaticDelay
This field specifies the Standard Deviation Troposphere Vertical Hydro Static Delay Error bound which is the standard
deviation for an overbounding model that bounds the residual troposphere error in the vertical hydro static delay
component.
Scale factor 0.005 m; range 0-1.275 m.
meanTroposphereVerticalWetDelay
This field specifies the Mean Troposphere Vertical Wet Static Delay Error bound which is the mean value for an
overbounding model that bounds the residual troposphere error in the vertical wet delay component.
The bound is meanTroposphereVerticalWetDelay + K * stdDevTroposphere VerticalWetDelay and shall be so that the
probability of it to be exceeded shall be lower than IRallocation for irMinimum < IRallocation < irMaximum, where K =
normInv(IRallocation / 2) and irMinimum, irMaximum as provided in IE GNSS-Integrity-ServiceParameters.
This IRallocation is a fraction of the Target Integrity Risk that represents the integrity risk budget available.
Scale factor 0.005 m; range 0-1.275 m.
stdDevTroposphereVerticalWetDelay
This field specifies the Standard Deviation Troposphere Vertical Wet Static Delay Error bound which is the standard
deviation for an overbounding model that bounds the residual troposphere error in the vertical wet delay component.
Scale factor 0.005 m; range 0-1.275 m.
meanTroposphereVerticalHydroStaticDelayRate
This field specifies the Mean Troposphere Vertical Hydro Static Delay Rate Error bound which is the mean value for
an overbounding model that bounds the residual troposphere rate error in the vertical hydro static delay component.
The bound is meanTroposphereVerticalHydroStaticDelayRate + K * stdDev Troposphere VerticalHydroStaticDelayRate
and shall be so that the probability of it to be exceeded shall be lower than IRallocation for irMinimum < IRallocation <
irMaximum, where K = normInv(IRallocation / 2) and irMinimum, irMaximum as provided in IE GNSS-Integrity-
ServiceParameters.
This IRallocation is a fraction of the Target Integrity Risk that represents the integrity risk budget available.
Scale factor 0.00005 m/s; range 0-0.01275 m/s.
stdDevTroposphereVerticalHydroStaticDelayRate
This field specifies the Standard Deviation Troposphere Vertical Hydro Static Delay Rate Error bound which is the
standard deviation for an overbounding model that bounds the residual troposphere rate error in the vertical hydro
static delay component.
Scale factor 0.00005 m/s; range 0-0.01275 m/s.
meanTroposphereVerticalWetDelayRate
This field specifies the Mean Troposphere Vertical Wet Static Delay Rate Error bound which is the mean value for an
overbounding model that bounds the residual troposphere rate error in the vertical wet delay component.
The bound is meanTroposphereVerticalWetDelayRate + K * stdDev Troposphere VerticalWetDelayRate and shall be so
that the probability of it to be exceeded shall be lower than IRallocation for irMinimum < IRallocation < irMaximum,
where K = normInv(IRallocation / 2) and irMinimum, irMaximum as provided in IE GNSS-Integrity-ServiceParameters.
This IRallocation is a fraction of the Target Integrity Risk that represents the integrity risk budget available.
Scale factor 0.00005 m/s; range 0-0.01275 m/s.
stdDevTroposphereVerticalWetDelayRate
This field specifies the Standard Deviation Troposphere Vertical Wet Static Delay Rate Error bound which is the
standard deviation for an overbounding model that bounds the residual troposphere rate error in the vertical wet delay
component.
Scale factor 0.00005 m/s; range 0-0.01275 m/s.

### Relationship Between SSR Troposphere Quality and URA Indicator and Physical Quantity

| | | | SSR troposphere quality indicator |
|---|---|---|---|
| CLASS | VALUE | Index | and SSR URA Q [mm] |
| 7 | 7 | 63 | 5466.50 < Q |
| 7 | 6 | 62 | 4919.75 < Q ≤ 5466.50 |
| 7 | 5 | 61 | 4373.75 < Q ≤ 4919.75 |
| 7 | 4 | 60 | 3826.25 < Q ≤ 4373.00 |
| 7 | 3 | 59 | 3279.50 < Q ≤ 3826.25 |
| 7 | 2 | 58 | 2732.75 < Q ≤ 3279.50 |
| 7 | 1 | 57 | 2186.00 < Q ≤ 2732.75 |
| 7 | 0 | 56 | 2003.75 < Q ≤ 2186.00 |
| 6 | 7 | 55 | 1821.50 < Q ≤ 2003.75 |
| 6 | 6 | 54 | 1639.25 < Q ≤ 1821.50 |
| 6 | 5 | 53 | 1457.00 < Q ≤ 1639.25 |
| 6 | 4 | 52 | 1274.75 < Q ≤ 1457.00 |
| 6 | 3 | 51 | 1092.50 < Q ≤ 1274.75 |
| 6 | 2 | 50 | 910.25 < Q ≤ 1092.50 |
| 6 | 1 | 49 | 728.00 < Q ≤ 910.25 |
| 6 | 0 | 48 | 667.25 < Q ≤ 728.00 |
| 5 | 7 | 47 | 606.50 < Q ≤ 667.25 |
| 5 | 6 | 46 | 545.75 < Q ≤ 606.50 |
| 5 | 5 | 45 | 485.00 < Q ≤ 545.75 |
| 5 | 4 | 44 | 424.25 < Q ≤ 485.00 |
| 5 | 3 | 43 | 363.50 < Q ≤ 425.25 |
| 5 | 2 | 42 | 302.75 < Q ≤ 363.50 |
| 5 | 1 | 41 | 242.00 < Q ≤ 302.75 |
| 5 | 0 | 40 | 221.75 < Q ≤ 242.00 |
| 4 | 7 | 39 | 201.50 < Q ≤ 221.75 |
| 4 | 6 | 38 | 181.25 < Q ≤ 201.50 |
| 4 | 5 | 37 | 161.00 < Q ≤ 181.25 |
| 4 | 4 | 36 | 140.75 < Q ≤ 161.00 |
| 4 | 3 | 35 | 120.50 < Q ≤ 140.75 |
| 4 | 2 | 34 | 100.25 < Q ≤ 120.50 |
| 4 | 1 | 33 | 80.00 < Q ≤ 100.25 |
| 4 | 0 | 32 | 73.25 < Q ≤ 80.00 |
| 3 | 7 | 31 | 66.50 < Q ≤ 73.25 |
| 3 | 6 | 30 | 59.75 < Q ≤ 66.50 |
| 3 | 5 | 29 | 53.00 < Q ≤ 59.75 |
| 3 | 4 | 28 | 46.25 < Q ≤ 53.00 |
| 3 | 3 | 27 | 39.50 < Q ≤ 46.25 |
| 3 | 2 | 26 | 32.75 < Q ≤ 39.50 |
| 3 | 1 | 25 | 26.00 < Q ≤ 32.75 |
| 3 | 0 | 24 | 23.75 < Q ≤ 26.00 |
| 2 | 7 | 23 | 21.50 < Q ≤ 23.75 |
| 2 | 6 | 22 | 19.25 < Q ≤ 21.50 |
| 2 | 5 | 21 | 17.00 < Q ≤ 19.25 |
| 2 | 4 | 20 | 14.75 < Q ≤ 17.00 |
| 2 | 3 | 19 | 12.50 < Q ≤ 14.75 |
| 2 | 2 | 18 | 10.25 < Q ≤ 12.50 |
| 2 | 1 | 17 | 8.00 < Q ≤ 10.25 |
| 2 | 0 | 16 | 7.25 < Q ≤ 8.00 |
| 1 | 7 | 15 | 6.50 < Q ≤ 7.25 |
| 1 | 6 | 14 | 5.75 < Q ≤ 6.50 |
| 1 | 5 | 13 | 5.00 < Q ≤ 5.75 |
| 1 | 4 | 12 | 4.25 < Q ≤ 5.00 |
| 1 | 3 | 11 | 3.50 < Q ≤ 4.25 |
| 1 | 2 | 10 | 2.75 < Q ≤ 3.50 |
| 1 | 1 | 9 | 2.00 < Q ≤ 2.75 |
| 1 | 0 | 8 | 1.75 < Q ≤ 2.00 |
| 0 | 7 | 7 | 1.50 < Q ≤ 1.75 |
| 0 | 6 | 6 | 1.25 < Q ≤ 1.50 |
| 0 | 5 | 5 | 1.00 < Q ≤ 1.25 |
| 0 | 4 | 4 | 0.75 < Q ≤ 1.00 |
| 0 | 3 | 3 | 0.50 < Q ≤ 0.75 |
| 0 | 2 | 2 | 0.25 < Q ≤ 0.50 |
| 0 | 1 | 1 | Q ≤ 0.25 |
| 0 | 0 | 0 | undefined/unknown |

### SUMMARY

There currently exist certain challenge(s). In particular, a representation of assistance data per GNSS constellation is not efficient if the data provided for one GNSS can be applied to all other GNSS(s). As used herein, and unless otherwise indicated, the terms “a GNSS constellation”, “one type of GNSS constellation”, “one GNSS” and, more generally, “GNSS” refer to a single type/form of GNSS, e.g. one of GPS, Galileo, QZSS, GLONASS, etc.

Certain aspects of the disclosure and their embodiments may provide solutions to these or other challenges. In some solutions, a tropospheric delay correction is only provided for one GNSS by the location server to the UE, and refrained from being provided for the other GNSS(s) in the same epoch or time interval. That is, tropospheric delay correction data can be provided by the location server for use with GPS, and the location server can refrain from providing tropospheric delay correction data for other GNSS constellations in the same epoch or time interval.

In some solutions, a UE that obtains tropospheric delay corrections for one GNSS will not expect tropospheric delay corrections for other GNSS in the same epoch or time interval. The UE can use the obtained tropospheric delay corrections for all GNSS. That is, the UE can obtain tropospheric delay correction data for use with GPS, and will not expect to receive tropospheric delay correction data for other (non-GPS) GNSS(s) in the same epoch or time interval. The UE can use the obtained tropospheric delay corrections for all types of GNSS (e.g. GPS, and Galileo, GLONASS, etc.).

According to a first aspect, there is provided a method performed by a UE. The method comprises the UE receiving first assistance data for a first GNSS from a network node, and receiving second assistance data for a second GNSS from the network node. The first assistance data comprises tropospheric delay correction data, and the second assistance data does not include tropospheric delay correction data.

According to a second aspect, there is provided a method performed by a network node. The method comprises the network node sending first assistance data for a first GNSS to a UE, and sending second assistance data for a second GNSS to the UE. The first assistance data comprises tropospheric delay correction data, and the second assistance data does not include tropospheric delay correction data.

According to a third aspect, there is provided a computer program product comprising a computer readable medium having computer readable code embodied therein, the computer readable code being configured such that, on execution by a suitable computer or processor, the computer or processor is caused to perform the method according to the first aspect, the second aspect, or any embodiment thereof.

According to a fourth aspect, there is provided a UE configured to perform the method according to the first aspect or any embodiment thereof.

According to a fifth aspect, there is provided a UE comprising a processor and a memory, said memory containing instructions executable by said processor whereby said UE is operative to perform the method according to the first aspect or any embodiment thereof.

According to a sixth aspect, there is provided a network node configured to perform the method according to the second aspect or any embodiment thereof.

According to a seventh aspect, there is provided a network node comprising a processor and a memory, said memory containing instructions executable by said processor whereby said network node is operative to perform the method according to the second aspect or any embodiment thereof.

Certain embodiments may provide one or more of the following technical advantage(s). An advantage of the proposed solution is that the distribution of tropospheric delay correction assistance data becomes more efficient where a UE can obtain one set of data applicable for all GNSS constellations.

The solutions can also enable the UE to start processing data without awaiting data for other GNSS constellations. In case the data is broadcast from a network node to the UE, the UE does not need to decode data for other GNSS constellations in case the already-obtained tropospheric delay corrections are valid for all GNSS constellations.

### BRIEF DESCRIPTION OF THE DRAWINGS

Some of the embodiments contemplated herein will now be described more fully with reference to the accompanying drawings, in which:

FIG. 1 shows an architecture for supporting positioning in communication networks;

FIG. 2 illustrates atmospheric tropospheric delays between a UE and satellites;

FIG. 3 is a detailed illustration of an architecture for supporting positioning in communication networks;

FIG. 4 is a signalling diagram showing the signalling between a UE and a network node in a communication network;

FIG. 5 is a flow chart illustrating methods performed by a UE;

FIG. 6 is a flow chart illustrating methods performed by a network node;

FIG. 7 is a flow chart illustrating another method performed by a UE;

FIG. 8 is a flow chart illustrating another method performed by a network node;

FIG. 9 shows an example of a communication system in accordance with some embodiments;

FIG. 10 shows a UE in accordance with some embodiments;

FIG. 11 shows a network node in accordance with some embodiments; and

FIG. 12 is a block diagram illustrating a virtualization environment in which functions implemented by some embodiments may be virtualized.

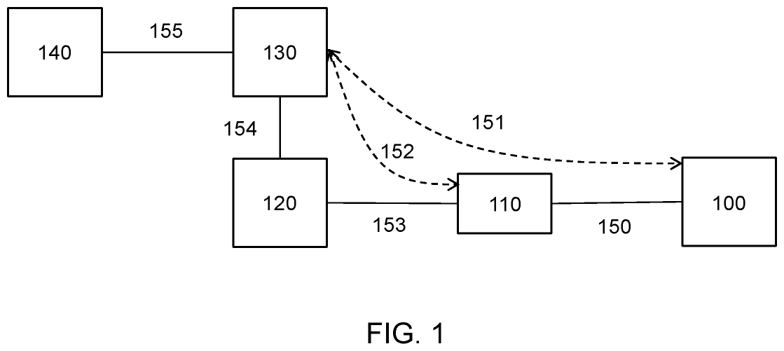

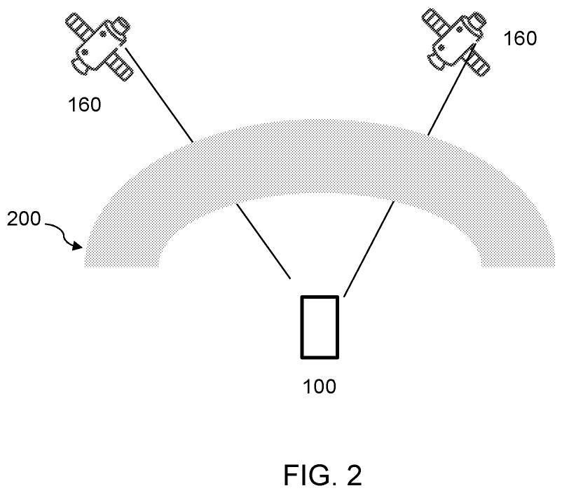

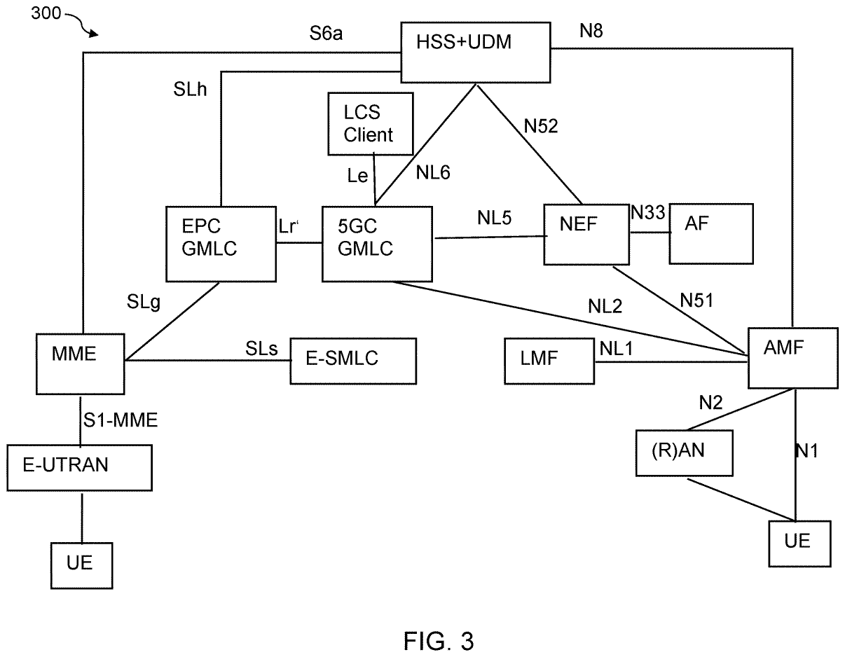

### DETAILED DESCRIPTION

Some of the embodiments contemplated herein will now be described more fully with reference to the accompanying drawings. Embodiments are provided by way of example to convey the scope of the subject matter to those skilled in the art. Additional information may also be found in the Appendices.

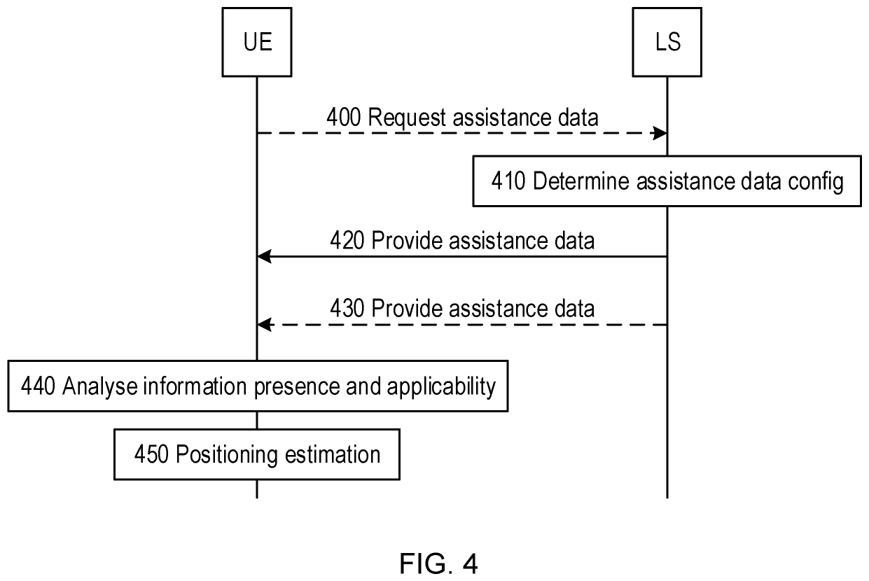

FIG. 4. is a signalling diagram showing the signalling between a UE (or any other type of wireless device that uses GNSS signals to determine its position) and a network node in a communication network according to an exemplary embodiment of the techniques described herein. In some embodiments the network node is a location server (LS) or Location Management Function (LMF) (e.g. in a 4G network or a 5G network), or other network node that is responsible for, or involved in, positioning calculations and/or providing assistance data for UEs in the network. It will be appreciated that a UE typically communicates with nodes in the core network via one or more RAN nodes (base stations), but those intermediate communication links or hops are not shown in FIG. 4 for brevity.

As noted above, the techniques described herein provides that a tropospheric delay correction is provided for one GNSS by the location server to the UE, and tropospheric delay correction data is not provided for the other GNSS(s) in the same epoch or time interval. In general, tropospheric delay correction data is a set of correction values used to compensate for delays in satellite signals caused by the troposphere.

In some solutions, a UE that obtains tropospheric delay corrections for one GNSS will not expect to receive (and will not receive) tropospheric delay corrections for other GNSS in the same epoch or time interval. The UE can use the obtained tropospheric delay corrections for all GNSSs.

Optionally, as shown by signal 400, a UE may send a request for assistance data from a network node. This request 400 may be a specific request for assistance data with tropospheric delay correction, or it may be a general request for assistance data. This request 400 is received by the LS.

In step 410 the network node determines an assistance data configuration for tropospheric delay correction. and distributes the configured assistance data in a first set of assistance data (shown by signal 420) and optionally in a second set of assistance data (shown by signal 430). Determining an assistance data configuration in step 410 can include determining which assistance data to send to the device, determining the tropospheric delay correction data to include in the transmission, and/or determining whether to send the assistance data for multiple types of GNSS in one or multiple sets of assistance data.

The assistance data can comprise parameters and/or values (e.g. specific settings/configurations) relating to a GNSS that can assist a UE in performing positioning measurements/calculations using the GNSS.

The network node configuration of tropospheric delay corrections can comprise including the tropospheric delay correction data together with other assistance data relating to a first GNSS constellation, e.g. GPS. The network node (LS) then refrains from including tropospheric delay correction data with assistance data that relates to a second (different) GNSS constellation, e.g. GALILEO, QZSS, GLONASS, BeiDou, etc.

In some embodiments, the first set of assistance data 420 can include the tropospheric delay correction data in the assistance data for the first GNSS constellation, and the first set of assistance data 420 can also include assistance data for a second (and further) GNSS constellation(s). As noted, the assistance data for the second GNSS constellation does not include tropospheric delay correction data.

In another embodiment, the first set of assistance data 420 can include the tropospheric delay correction data in the assistance data for the first GNSS constellation, and assistance data for the second GNSS constellation can be included in the second set of assistance data 430. The assistance data for the second GNSS does not include tropospheric delay correction data. In these embodiments, the first set of assistance data 420 and the second set of assistance data 430 are sent separately to the UE.

In some embodiments, the network node may indicate the presence or non-presence of the tropospheric delay correction data per GNSS constellation, where a ‘presence’ indication for the tropospheric delay correction for one GNSS constellation indicates to the UE that the network node is refraining from including the tropospheric delay correction data in assistance data for other GNSS constellations.

In step 440, the UE analyses the presence and availability of the tropospheric delay corrections, and in step 450 estimates the position based on GNSS measurements and the obtained assistance data (which includes the tropospheric delay correction data). Step 440 can comprise the UE analysing the received set(s) of assistance data to determine what information has been provided, and in particular analysing the received set(s) of assistance data to determine if tropospheric delay correction data has been included.

On including the tropospheric delay corrections data together with other assistance data relating to a first GNSS constellation, e.g. GPS, and sending this to the UE in step 420, the network node can start a timer or otherwise monitor an amount of time since the tropospheric delay correction data was sent to the UE. Until the timer expires or a specific time interval or epoch has passed since the sending of the tropospheric delay correction data to the UE in step 420, the network node refrains from including tropospheric delay correction data in any subsequent assistance data sent to the UE relating to any other GNSS, or any subsequent assistance data sent that relates to the first GNSS. The duration of the timer or specific time interval may be set or predefined based on an amount of time that the tropospheric delay correction data is expected to be valid.

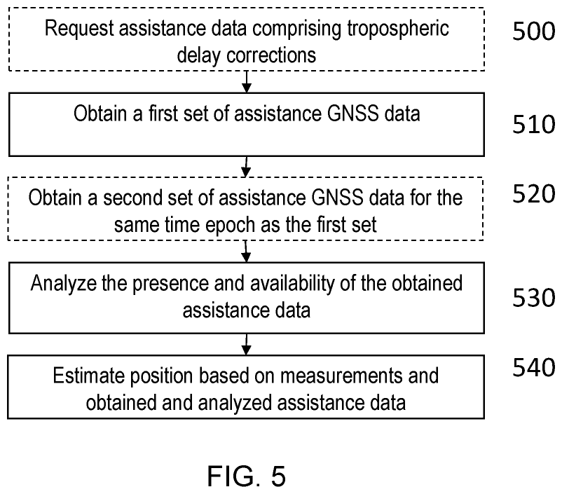

The flow chart in FIG. 5 illustrates an exemplary method of operating a UE according to the techniques described herein. In optional step 500, the UE requests assistance data from the network node. This request can comprise a specific request for tropospheric delay corrections, or the request can be a general request for assistance data.

In step 510, the UE obtains (receives) from a network node a first set of assistance data comprising assistance data relating to a first GNSS, which also includes tropospheric delay corrections data. In some embodiments, the first set of assistance data also comprises assistance data for a second (different) GNSS. The first set of assistance data may also include assistance data for a third (or more) GNSSs. The assistance data for the second (or more) GNSS(s) does not include tropospheric delay correction data.

In some embodiments, including embodiments where the first set of assistance data only includes assistance data for one type of GNSS, the UE can obtain (receive) a second set of assistance data from the network node (step 520). The second set of assistance data comprises assistance data relating to a different GNSS to the GNSS that the first set of assistance data relates to. The second set of assistance data does not comprise tropospheric delay corrections. The second set of assistance data is received from the network node separately to the first set of assistance data.

In step 530, based on the received assistance data, the UE can analyse the presence and availability of the tropospheric delay corrections data. Tropospheric delay correction information/data provided in the assistance data for a first GNSS constellation (e.g. GPS) is considered valid for a second GNSS constellation (e.g. GALILEO, GLONASS, BeiDou, . . . ). Furthermore, the UE may not expect to find/receive tropospheric delay corrections information with assistance data for a second GNSS constellation if it already has been provided with tropospheric delay correction in assistance data for a first GNSS constellation. Similarly, if tropospheric delay corrections information is not provided with a second GNSS constellation, the UE can expect the tropospheric delay correction data to be provided with assistance data for a first GNSS constellation.

In particular, following receipt of tropospheric delay corrections data together with other assistance data relating to a first GNSS constellation, e.g. GPS, the UE can start a timer or otherwise monitor an amount of time since the tropospheric delay correction data was received from the network node. Until the timer expires or a specific time interval or epoch has passed since the receipt of the tropospheric delay correction data from the network node in step 420, the UE will know that the network node will refrain from including tropospheric delay correction data in any subsequent assistance data sent to the device relating to any other GNSS, or any subsequent assistance data sent relating to the first GNSS. The duration of the timer or specific time interval may be set or predefined based on an amount of time that the tropospheric delay correction data is expected to be valid.

The techniques described herein allow the UE to start processing data without waiting for data for other GNSS constellations. In the case where the assistance data is broadcasted from the network node to the UE, the UE does not need to decode data for other GNSS constellations in the event that the already-obtained tropospheric delay corrections data is valid for all GNSS constellations.

Finally, in step 540, given GNSS measurements and the obtained tropospheric delay corrections data, the device estimates its position.

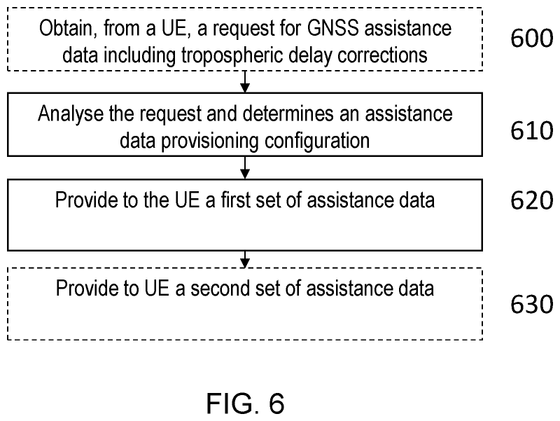

The flow chart in FIG. 6 illustrates an exemplary method of operating a network node (e.g. a Location Server) according to the techniques described herein. In optional step 600, the network node receives a request for assistance data from a UE. This request can comprise a specific request for tropospheric delay corrections, or the request can be a general request for assistance data.

In step 610 the network node analyses the request and determines an assistance data provisioning configuration. The network node configuration of tropospheric delay corrections data determined in step 610 can comprise including the tropospheric delay correction in assistance data for a first GNSS constellation, e.g. GPS, and refraining from including tropospheric delay correction together with assistance data for a second GNSS constellation, e.g. GALILEO, GLONASS, BeiDou, etc.

In step 620, the network node sends a first set of assistance data comprising assistance data relating to a first GNSS to the UE, with this assistance data also including the tropospheric delay corrections data. In some embodiments, the first set of assistance data also comprises assistance data for a second (different) GNSS. The first set of assistance data may also include assistance data for a third (or more) GNSSs. The assistance data for the second (or more) GNSS(s) does not include tropospheric delay correction data.

In some embodiments, including embodiments where the first set of assistance data only includes assistance data for one type of GNSS, the network node can send a second set of assistance data to the UE (step 630). The second set of assistance data comprises assistance data relating to a different GNSS to the GNSS that the first set of assistance data relates to. The second set of assistance data does not comprise tropospheric delay corrections. The second set of assistance data is sent to the UE separately to the first set of assistance data.

In some embodiments, the network node may indicate presence and non-presence of the tropospheric delay correction data per GNSS constellation, where a presence indication of the tropospheric delay correction for one GNSS constellation indicates that the network node refrains from including the tropospheric delay correction data in assistance data for other GNSS constellations.

On sending the tropospheric delay corrections data to the UE together with other assistance data relating to a first GNSS constellation in step 620, the network node can start a timer or otherwise monitor an amount of time since the tropospheric delay correction data was sent to the UE. Until the timer expires or a specific time interval or epoch has passed since the sending of the tropospheric delay correction data to the UE in step 620, the network node refrains from including tropospheric delay correction data in any subsequent assistance data sent to the UE relating to any other GNSS, or any subsequent assistance data sent that relates to the first GNSS. The duration of the timer or specific time interval may be set or predefined based on an amount of time that the tropospheric delay correction data is expected to be valid.

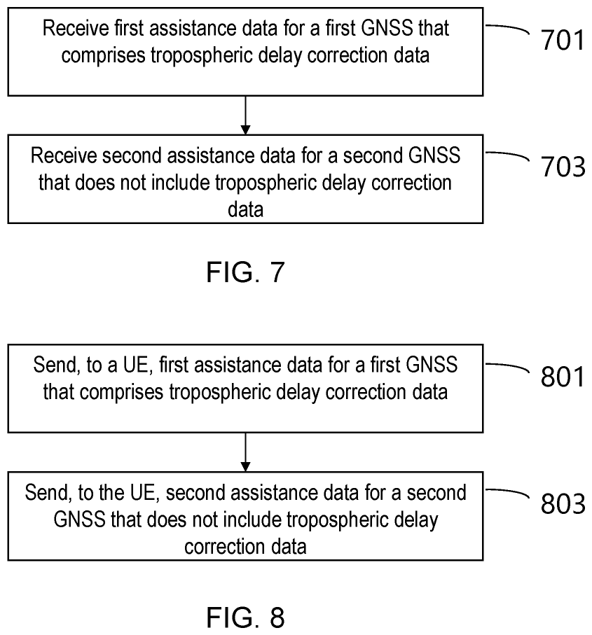

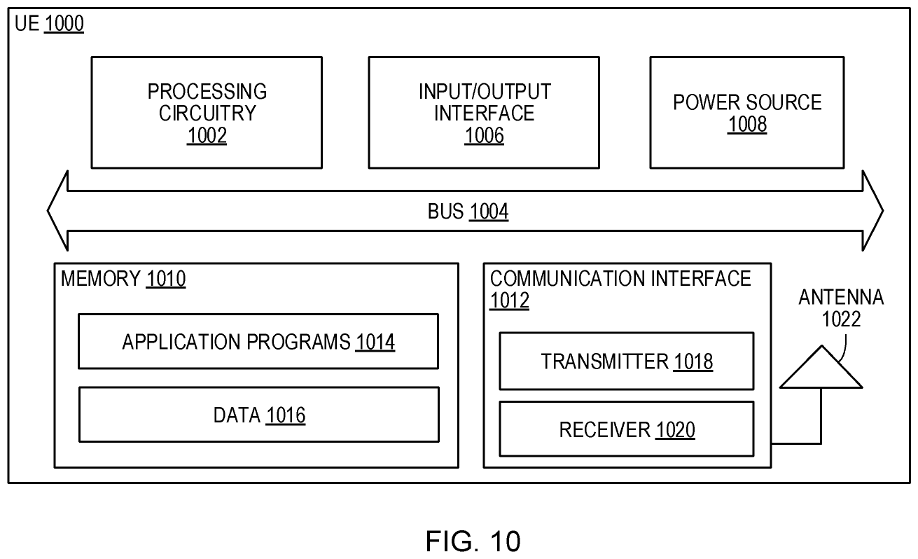

FIG. 7 is a flow chart illustrating a method according to various embodiments performed by a UE. The UE may perform the method in response to executing suitably formulated computer readable code. The computer readable code may be embodied or stored on a computer readable medium, such as a memory chip, optical disc, or other storage medium. The computer readable medium may be part of a computer program product. The UE may be as described below with reference to FIG. 10.

In step 701, the UE receives first assistance data for a first GNSS from a network node. The first assistance data comprises tropospheric delay correction data. The network node may be a Location Server (LS), or a Location

### Management Function (LMF).

In step 703, the UE receives second assistance data for a second GNSS from the network node. The second assistance data does not include tropospheric delay correction data.

The second GNSS may be a different GNSS constellation to the first GNSS (i.e. they are different types of GNSS). For example, the first GNSS can be one of GPS, Galileo, GLONASS, BeiDou and QZSS, and the second GNSS is a different one of GPS, Galileo, GLONASS, BeiDou and QZSS.

The tropospheric delay correction data received in step 701 is valid for use with signals received from any GNSS (optionally within a particular time period or for a predetermined time). The tropospheric delay correction data received in step 701 can be used with signals received from any GNSS. In this case, the UE may receive an indication from the network node that the tropospheric delay correction data is valid for use with signals received from any GNSS. This indication can be received with the first assistance data, or provided separately.

The method performed by the UE may further comprise the UE determining the position of the UE using measurements of signals from the first GNSS and/or the second GNSS. In determining the position, the UE uses the tropospheric delay correction data received in the first assistance data. In particular, the UE can use the tropospheric delay correction data received in the first assistance data when determining the position of the UE from measurements of signals from the second GNSS.

The first assistance data and the second assistance data may be received in a same set of assistance data. In other words, steps 701 and 703 can be performed at the same time. Alternatively, the second assistance data is received separately from the first assistance data.

The second assistance data may be received within a predetermined time period of the receipt of the first assistance data.

The UE may start a timer when the first assistance data is received in step 701, or monitor a time since the first assistance data was received. In this case, the UE does not expect to receive (further/new) tropospheric delay correction data from the network node while the timer is running or until a predetermined period of time has passed since the first assistance data was received. The UE can use the tropospheric delay correction data received in the first assistance data with signals received from any GNSS while the timer is running or until a predetermined period of time has passed since the first assistance data was received.

The method performed by the UE may comprise the UE analysing the presence and/or availability of tropospheric delay correction data in the received first assistance data.

In some cases, the UE may send a request for assistance data to the network node. This request may have been sent prior to receiving the first assistance data in step 701. The request may also request tropospheric delay correction data from the network node.

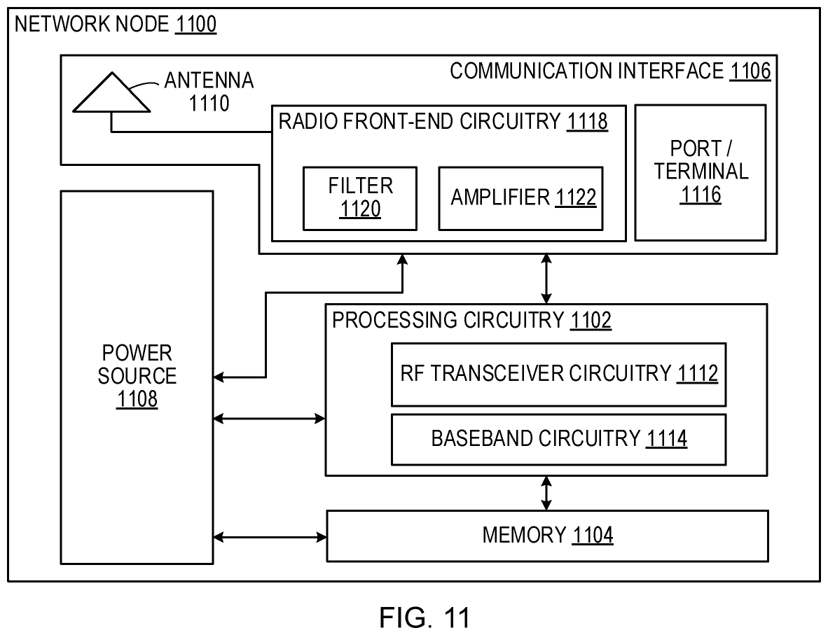

FIG. 8 is a flow chart illustrating a method according to various embodiments performed by a network node. The network node may be a Location Server (LS), or a Location Management Function (LMF). The network node may perform the method in response to executing suitably formulated computer readable code. The computer readable code may be embodied or stored on a computer readable medium, such as a memory chip, optical disc, or other storage medium. The computer readable medium may be part of a computer program product. The network node may be as described below with reference to FIG. 11.

In step 801, the network node sends first assistance data for a first GNSS to a UE. The first assistance data comprises tropospheric delay correction data.

In step 803, the network node sends second assistance data for a second GNSS to the UE. The second assistance data does not include tropospheric delay correction data.

The second GNSS may be a different GNSS constellation to the first GNSS (i.e. they are different types of GNSS). For example, the first GNSS can be one of GPS, Galileo, GLONASS, BeiDou and QZSS, and the second GNSS is a different one of GPS, Galileo, GLONASS, BeiDou and QZSS.

The UE is to determine the position of the UE using measurements of signals from the first GNSS and/or the second GNSS, and the tropospheric delay correction data received in the first assistance data. That is, the tropospheric delay correction data is valid for use with signals received from any GNSS (optionally within a particular time period or for a predetermined time). The tropospheric delay correction data sent in step 801 can be used with signals received from any GNSS. The network node may send an indication to the UE to indicate that the tropospheric delay correction data is valid for use with signals received from any GNSS. This indication may be sent with the first assistance data in step 701, or sent separately.

The network node may send the first assistance data and the second assistance data in a same set of assistance data. In other words, steps 801 and 803 can be performed at the same time. Alternatively, the second assistance data is sent separately to the first assistance data.

The second assistance data may be sent in step 803 within a predetermined time period of the sending of the first assistance data in step 801.

The network node may start a timer when the first assistance data is sent to the UE in step 801, or monitor a time since the first assistance data was sent in step 801. In this case, the network node does not send (new/further) tropospheric delay correction data to the UE while the timer is running or until a predetermined period of time has passed since the first assistance data was sent. The UE will use the tropospheric delay correction data sent in step 801 with signals received from any GNSS while the timer is running or until the predetermined period of time has passed since the first assistance data was sent.

In some embodiments, the network node may determine an assistance data configuration to use for sending assistance data to a UE. The first assistance data and the second assistance data may be sent to the UE (in steps 801 and 803) in accordance with the determined assistance data configuration.

In some cases, the network node may receive a request for assistance data from the UE. The first assistance data sent in step 801 may have been sent in response to receiving this request. The request may also request tropospheric delay correction data.

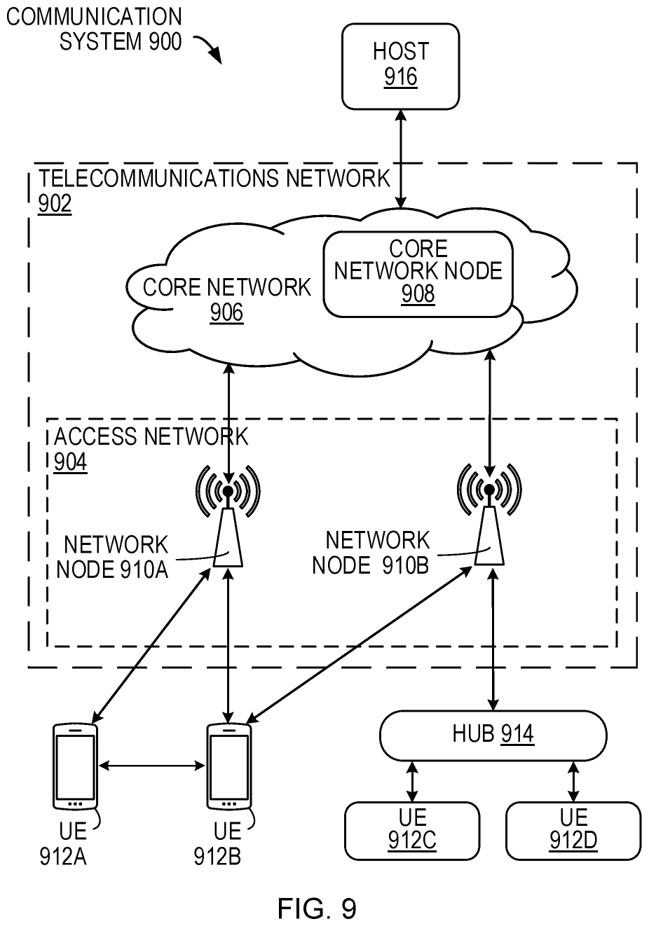

FIG. 9 shows an example of a communication system 900 in accordance with some embodiments.

In the example, the communication system 900 includes a telecommunication network 902 that includes an access network 904, such as a radio access network (RAN), and a core network 906, which includes one or more core network nodes 908. The access network 904 includes one or more access network nodes, such as access network nodes 910a and 910b (one or more of which may be generally referred to as access network nodes 910), or any other similar 3rd Generation Partnership Project (3GPP) access node or non-3GPP access point. The access network nodes 910 facilitate direct or indirect connection of wireless devices (also referred to interchangeably herein as user equipment (UE)), such as by connecting UEs 912a, 912b, 912c, and 912d (one or more of which may be generally referred to as UEs 912) to the core network 906 over one or more wireless connections. The access network nodes 910 may be, for example, access points (APs) (e.g. radio access points), base stations (BSs) (e.g. radio base stations, Node Bs, evolved Node Bs (eNBs) and NR NodeBs (gNBs)).

Unless otherwise indicated, the term ‘network node’ is used herein to refer to both access network nodes 910 and core network nodes 908.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system 900 may include any number of wired or wireless networks, network nodes, UEs, and/or any other components or systems that may facilitate or participate in the communication of data and/or signals whether via wired or wireless connections. The communication system 900 may include and/or interface with any type of communication, telecommunication, data, cellular, radio network, and/or other similar type of system.

The wireless devices/UEs 912 may be any of a wide variety of communication devices, including wireless devices arranged, configured, and/or operable to communicate wirelessly with the network nodes 910 and other communication devices. Similarly, the access network nodes 910 are arranged, capable, configured, and/or operable to communicate directly or indirectly with the UEs 912 and/or with other network nodes or equipment in the telecommunication network 902 to enable and/or provide network access, such as wireless network access, and/or to perform other functions, such as administration in the telecommunication network 902.

In the depicted example, the core network 906 connects the access network nodes 910 to one or more hosts, such as host 916. These connections may be direct or indirect via one or more intermediary networks or devices. In other examples, network nodes may be directly coupled to hosts. The core network 906 includes one more core network nodes (e.g. core network node 908) that are structured with hardware and software components. Features of these components may be substantially similar to those described with respect to the wireless devices/UEs, access network nodes, and/or hosts, such that the descriptions thereof are generally applicable to the corresponding components of the core network node 908. Example core network nodes include functions of one or more of a location server (LS), an E-SMLC, a SLP, a Location Management Function (LMF), a Mobile Switching Center (MSC), Mobility Management Entity (MME), Home Subscriber Server (HSS), Access and Mobility Management Function (AMF),

Session Management Function (SMF), Authentication Server Function (AUSF), Subscription Identifier De-concealing function (SIDF), Unified Data Management (UDM), Security Edge Protection Proxy (SEPP), Network Exposure Function (NEF), and/or a User Plane Function (UPF).

The host 916 may be under the ownership or control of a service provider other than an operator or provider of the access network 904 and/or the telecommunication network 902, and may be operated by the service provider or on behalf of the service provider. The host 916 may host a variety of applications to provide one or more services. Examples of such applications include the provision of live and/or pre-recorded audio/video content, data collection services, for example, retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system 900 of FIG. 9 enables connectivity between the wireless devices/UEs, network nodes, and hosts. In that sense, the communication system may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 3G, 4G, 5G standards, or any applicable future generation standard (e.g. 6th Generation (6G));
wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, the telecommunication network 902 is a cellular network that implements 3GPP standardized features. Accordingly, the telecommunications network 902 may support network slicing to provide different logical networks to different devices that are connected to the telecommunication network 902. For example, the telecommunications network 902 may provide Ultra Reliable Low Latency Communication (URLLC) services to some UEs, while providing Enhanced Mobile Broadband (eMBB) services to other UEs, and/or Massive Machine Type Communication (mMTC)/Massive IoT services to yet further UEs.

In some examples, the UEs 912 are configured to transmit and/or receive information without direct human interaction. For instance, a UE may be designed to transmit information to the access network 904 on a predetermined schedule, when triggered by an internal or external event, or in response to requests from the access network 904. Additionally, a UE may be configured for operating in single- or multi-RAT or multi-standard mode. For example, a UE may operate with any one or combination of Wi-Fi, NR (New Radio) and LTE, i.e. being configured for multi-radio dual connectivity (MR-DC), such as E-UTRAN (Evolved-UMTS Terrestrial Radio Access Network) New Radio-Dual Connectivity (EN-DC).

In the example illustrated in FIG. 9, the hub 914 communicates with the access network 904 to facilitate indirect communication between one or more UEs (e.g. UE 912c and/or 912d) and access network nodes (e.g. access network node 910b). In some examples, the hub 914 may be a controller, router, a content source and analytics node, or any of the other communication devices described herein regarding UEs. For example, the hub 914 may be a broadband router enabling access to the core network 906 for the UEs. As another example, the hub 914 may be a controller that sends commands or instructions to one or more actuators in the UEs. Commands or instructions may be received from the UEs, network nodes 910, or by executable code, script, process, or other instructions in the hub 914. As another example, the hub 914 may be a data collector that acts as temporary storage for UE data and, in some embodiments, may perform analysis or other processing of the data. As another example, the hub 914 may be a content source. For example, for a UE that is a VR headset, display, loudspeaker or other media delivery device, the hub 914 may retrieve VR assets, video, audio, or other media or data related to sensory information via a network node, which the hub 914 then provides to the UE either directly, after performing local processing, and/or after adding additional local content. In still another example, the hub 914 acts as a proxy server or orchestrator for the UEs, in particular in if one or more of the UEs are low energy IoT devices.

The hub 914 may have a constant/persistent or intermittent connection to the network node 910b. The hub 914 may also allow for a different communication scheme and/or schedule between the hub 914 and UEs (e.g. UE 912c and/or 912d), and between the hub 914 and the core network 906. In other examples, the hub 914 is connected to the core network 906 and/or one or more UEs via a wired connection. Moreover, the hub 914 may be configured to connect to an M2M service provider over the access network 904 and/or to another UE over a direct connection. In some scenarios, UEs may establish a wireless connection with the network nodes 910 while still connected via the hub 914 via a wired or wireless connection. In some embodiments, the hub 914 may be a dedicated hub—that is, a hub whose primary function is to route communications to/from the UEs from/to the network node 910b. In other embodiments, the hub 914 may be a non-dedicated hub—that is, a device which is capable of operating to route communications between the UEs and network node 910b, but which is additionally capable of operating as a communication start and/or end point for certain data channels.

FIG. 10 shows a UE 1000 in accordance with some embodiments.

As used herein, a UE refers to a device capable, configured, arranged and/or operable to communicate wirelessly with network nodes and/or other UEs. Examples of a UE include, but are not limited to, a smart phone, mobile phone, cell phone, voice over IP (VOIP) phone, wireless local loop phone, desktop computer, personal digital assistant (PDA), wireless camera, gaming console or device, music storage device, playback appliance, wearable terminal device, wireless endpoint, mobile station, tablet, laptop, laptop-embedded equipment (LEE), laptop-mounted equipment (LME), smart device, wireless customer-premise equipment (CPE), vehicle-mounted or vehicle embedded/integrated wireless device, etc. Other examples include any UE identified by the 3rd Generation

Partnership Project (3GPP), including a narrow band internet of things (NB-IoT) UE, a machine type communication (MTC) UE, and/or an enhanced MTC (eMTC) UE.

A wireless device/UE may support device-to-device (D2D) communication, for example by implementing a 3GPP standard for sidelink communication, Dedicated Short-Range Communication (DSRC), vehicle-to-vehicle (V2V), vehicle-to-infrastructure (V2I), or vehicle-to-everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g. a smart sprinkler controller). Alternatively, a UE may represent a device that is not intended for sale to, or operation by, an end user but which may be associated with or operated for the benefit of a user (e.g. a smart power meter).

The UE 1000 includes processing circuitry 1002 that is operatively coupled via a bus 1004 to an input/output interface 1006, a power source 1008, a memory 1010, a communication interface 1012, and/or any other component, or any combination thereof. Certain UEs may utilize all or a subset of the components shown in FIG. 10. The level of integration between the components may vary from one UE to another UE. Further, certain UEs may contain multiple instances of a component, such as multiple processors, memories, transceivers, transmitters, receivers, etc.

The processing circuitry 1002 is configured to process instructions and data and may be configured to implement any sequential state machine operative to execute instructions stored as machine-readable computer programs in the memory 1010. The processing circuitry 1002 may be implemented as one or more hardware-implemented state machines (e.g. in discrete logic, field-programmable gate arrays (FPGAs), application specific integrated circuits (ASICs), etc.); programmable logic together with appropriate firmware; one or more stored computer programs, general-purpose processors, such as a microprocessor or digital signal processor (DSP), together with appropriate software; or any combination of the above. For example, the processing circuitry 1002 may include multiple central processing units (CPUs). The processing circuitry 1002 may be operable to provide, either alone or in conjunction with other UE 1000 components, such as the memory 1010, to provide UE 1000 functionality. For example, the processing circuitry 1002 may be configured to cause the UE 1002 to perform the methods as described with reference to FIG. 4, 5 or 7.

In the example, the input/output interface 1006 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into the UE 1000. Examples of an input device include a touch-sensitive or presence-sensitive display, a camera (e.g. a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof.

An output device may use the same type of interface port as an input device. For example, a Universal Serial Bus (USB) port may be used to provide an input device and an output device.

In some embodiments, the power source 1008 is structured as a battery or battery pack. Other types of power sources, such as an external power source (e.g. an electricity outlet), photovoltaic device, or power cell, may be used. The power source 1008 may further include power circuitry for delivering power from the power source 1008 itself, and/or an external power source, to the various parts of the UE 1000 via input circuitry or an interface such as an electrical power cable. Delivering power may be, for example, for charging of the power source 1008. Power circuitry may perform any formatting, converting, or other modification to the power from the power source 1008 to make the power suitable for the respective components of the UE 1000 to which power is supplied.

The memory 1010 may be or be configured to include memory such as random access memory (RAM), read-only memory (ROM), programmable read-only memory (PROM), erasable programmable read-only memory (EPROM), electrically erasable programmable read-only memory (EEPROM), magnetic disks, optical disks, hard disks, removable cartridges, flash drives, and so forth. In one example, the memory 1010 includes one or more application programs 1014, such as an operating system, web browser application, a widget, gadget engine, or other application, and corresponding data 1016. The memory 1010 may store, for use by the UE 1000, any of a variety of various operating systems or combinations of operating systems.

The memory 1010 may be configured to include a number of physical drive units, such as redundant array of independent disks (RAID), flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as tamper resistant module in the form of a universal integrated circuit card (UICC) including one or more subscriber identity modules (SIMs), such as a USIM and/or ISIM, other memory, or any combination thereof. The UICC may for example be an embedded UICC (eUICC), integrated UICC (iUICC) or a removable UICC commonly known as ‘SIM card.’ The memory 1010 may allow the UE 1000 to access instructions, application programs and the like, stored on transitory or non-transitory memory media, to off-load data, or to upload data. An article of manufacture, such as one utilizing a communication system may be tangibly embodied as or in the memory 1010, which may be or comprise a device-readable storage medium.

The processing circuitry 1002 may be configured to communicate with an access network or other network using the communication interface 1012. The communication interface 1012 may comprise one or more communication subsystems and may include or be communicatively coupled to an antenna 1022. The communication interface 1012 may include one or more transceivers used to communicate, such as by communicating with one or more remote transceivers of another device capable of wireless communication (e.g. another UE or a network node in an access network). Each transceiver may include a transmitter 1018 and/or a receiver 1020 appropriate to provide network communications (e.g. optical, electrical, frequency allocations, and so forth). Moreover, the transmitter 1018 and receiver 1020 may be coupled to one or more antennas (e.g. antenna 1022) and may share circuit components, software or firmware, or alternatively be implemented separately.

In some embodiments, communication functions of the communication interface 1012 may include cellular communication, Wi-Fi communication, LPWAN communication, data communication, voice communication, multimedia communication, short-range communications such as Bluetooth, near-field communication, location-based communication such as the use of the global positioning system (GPS) to determine a location, another like communication function, or any combination thereof. Communications may be implemented in according to one or more communication protocols and/or standards, such as IEEE 802.11, Code Division Multiplexing Access (CDMA), Wideband Code Division Multiple Access (WCDMA), GSM, LTE, New Radio (NR), UMTS, WiMax, Ethernet, transmission control protocol/internet protocol (TCP/IP), synchronous optical networking (SONET), Asynchronous Transfer Mode (ATM), QUIC, Hypertext Transfer Protocol (HTTP), and so forth.

Regardless of the type of sensor, a UE may provide an output of data captured by its sensors, through its communication interface 1012, via a wireless connection to a network node. Data captured by sensors of a UE can be communicated through a wireless connection to a network node via another UE. The output may be periodic (e.g. once every 15 minutes if it reports the sensed temperature), random (e.g. to even out the load from reporting from several sensors), in response to a triggering event (e.g. when moisture is detected an alert is sent), in response to a request (e.g. a user initiated request), or a continuous stream (e.g. a live video feed of a patient).

As another example, a UE comprises an actuator, a motor, or a switch, related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or controls a robotic arm performing a medical procedure according to the received input.

A UE, when in the form of an Internet of Things (IoT) device, may be a device for use in one or more application domains, these domains comprising, but not limited to, city wearable technology, extended industrial application and healthcare. Non-limiting examples of such an IoT device are devices which are or which are embedded in: a connected refrigerator or freezer, a TV, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a head-mounted display for Augmented Reality (AR) or Virtual Reality (VR), a wearable for tactile augmentation or sensory enhancement, a water sprinkler, an animal- or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an IoT device comprises circuitry and/or software in dependence on the intended application of the IoT device in addition to other components as described in relation to the UE 1000 shown in FIG. 10.

As yet another specific example, in an IoT scenario, a UE may represent a machine or other device that performs monitoring and/or measurements, and transmits the results of such monitoring and/or measurements to another UE and/or a network node. The UE may in this case be an M2M device, which may in a 3GPP context be referred to as an MTC device. As one particular example, the UE may implement the 3GPP NB-IoT standard. In other scenarios, a UE may represent a vehicle, such as a car, a bus, a truck, a ship and an airplane, or other equipment that is capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g. by controlling an actuator) to increase or decrease the drone's speed. The first and/or the second UE can also include more than one of the functionalities described above. For example, a UE might comprise the sensor and the actuator, and handle communication of data for both the speed sensor and the actuators.

FIG. 11 shows a network node 1100 in accordance with some embodiments.

As used herein, network node includes equipment capable, configured, arranged and/or operable to communicate directly or indirectly with a UE and/or with other network nodes or equipment, in a telecommunication network. Examples of network nodes include, but are not limited to, access network nodes such as access points (APs) (e.g. radio access points), base stations (BSs) (e.g. radio base stations, Node Bs, evolved Node Bs (eNBs) and NR NodeBs (gNBs)). Other examples of network nodes include, but are not limited to, core network nodes such as nodes that include functions of one or more of a location server (LS), an E-SMLC, a SLP, a Location Management Function (LMF), a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), and/or a User Plane Function (UPF).

Base stations may be categorized based on the amount of coverage they provide (or, stated differently, their transmit power level) and so, depending on the provided amount of coverage, may be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS). Other examples of network nodes include multiple transmission point (multi-TRP) 5G access nodes, multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), Operation and Maintenance (O&M) nodes, Operations Support System (OSS) nodes, Self-Organizing Network (SON) nodes, positioning nodes (e.g. Evolved Serving Mobile Location Centers (E-SMLCs)), and/or Minimization of Drive Tests (MDTs).

The network node 1100 includes processing circuitry 1102, a memory 1104, a communication interface 1106, and a power source 1108, and/or any other component, or any combination thereof. The network node 1100 may be composed of multiple physically separate components (e.g. a NodeB component and a RNC component, or a BTS component and a BSC component, etc.), which may each have their own respective components. In certain scenarios in which the network node 1100 comprises multiple separate components (e.g. BTS and BSC components), one or more of the separate components may be shared among several network nodes. For example, a single RNC may control multiple NodeBs. In such a scenario, each unique NodeB and RNC pair, may in some instances be considered a single separate network node. In some embodiments, the network node 1100 may be configured to support multiple radio access technologies (RATs). In such embodiments, some components may be duplicated (e.g. separate memory 1104 for different RATs) and some components may be reused (e.g. a same antenna 1110 may be shared by different RATs). The network node 1100 may also include multiple sets of the various illustrated components for different wireless technologies integrated into network node 1100, for example GSM, WCDMA, LTE, NR, WiFi, Zigbee, Z-wave, LoRaWAN, Radio Frequency Identification (RFID) or Bluetooth wireless technologies. These wireless technologies may be integrated into the same or different chip or set of chips and other components within network node 1100. The processing circuitry 1102 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 1100 components, such as the memory 1104, to provide network node 1100 functionality. For example, the processing circuitry 1102 may be configured to cause the network node to perform the methods as described with reference to FIG. 4, 6 or 8.

In some embodiments, the processing circuitry 1102 includes a system on a chip (SOC). In some embodiments, the processing circuitry 1102 includes one or more of radio frequency (RF) transceiver circuitry 1112 and baseband processing circuitry 1114. In some embodiments, the radio frequency (RF) transceiver circuitry 1112 and the baseband processing circuitry 1114 may be on separate chips (or sets of chips), boards, or units, such as radio units and digital units. In alternative embodiments, part or all of RF transceiver circuitry 1112 and baseband processing circuitry 1114 may be on the same chip or set of chips, boards, or units.

The memory 1104 may comprise any form of volatile or non-volatile computer-readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device-readable and/or computer-executable memory devices that store information, data, and/or instructions that may be used by the processing circuitry 1102. The memory 1104 may store any suitable instructions, data, or information, including a computer program, software, an application including one or more of logic, rules, code, tables, and/or other instructions capable of being executed by the processing circuitry 1102 and utilized by the network node 1100. The memory 1104 may be used to store any calculations made by the processing circuitry 1102 and/or any data received via the communication interface 1106. In some embodiments, the processing circuitry 1102 and memory 1104 is integrated.

The communication interface 1106 is used in wired or wireless communication of signalling and/or data between network nodes, the access network, the core network, and/or a UE. As illustrated, the communication interface 1106 comprises port(s)/terminal(s) 1116 to send and receive data, for example to and from a network over a wired connection.

Where the network node 1100 is an access network node, the communication interface 1106 also includes radio front-end circuitry 1118 that may be coupled to, or in certain embodiments a part of, the antenna 1110. Where the network node 1100 is a core network node, such as a location server, the core network node may not include radio front-end circuitry 1118 and antenna 1110. Radio front-end circuitry 1118 comprises filters 1120 and amplifiers 1122. The radio front-end circuitry 1118 may be connected to an antenna 1110 and processing circuitry 1102. The radio front-end circuitry may be configured to condition signals communicated between antenna 1110 and processing circuitry 1102. The radio front-end circuitry 1118 may receive digital data that is to be sent out to other network nodes or UEs via a wireless connection. The radio front-end circuitry 1118 may convert the digital data into a radio signal having the appropriate channel and bandwidth parameters using a combination of filters 1120 and/or amplifiers 1122. The radio signal may then be transmitted via the antenna 1110. Similarly, when receiving data, the antenna 1110 may collect radio signals which are then converted into digital data by the radio front-end circuitry 1118. The digital data may be passed to the processing circuitry 1102. In other embodiments, the communication interface may comprise different components and/or different combinations of components.

In certain alternative embodiments, the access network node 1100 does not include separate radio front-end circuitry 1118, instead, the processing circuitry 1102 includes radio front-end circuitry and is connected to the antenna 1110. Similarly, in some embodiments, all or some of the RF transceiver circuitry 1112 is part of the communication interface 1106. In still other embodiments, the communication interface 1106 includes one or more ports or terminals 1116, the radio front-end circuitry 1118, and the RF transceiver circuitry 1112, as part of a radio unit (not shown), and the communication interface 1106 communicates with the baseband processing circuitry 1114, which is part of a digital unit (not shown).

The antenna 1110 may include one or more antennas, or antenna arrays, configured to send and/or receive wireless signals. The antenna 1110 may be coupled to the radio front-end circuitry 1118 and may be any type of antenna capable of transmitting and receiving data and/or signals wirelessly. In certain embodiments, the antenna 1110 is separate from the network node 1100 and connectable to the network node 1100 through an interface or port.

The antenna 1110, communication interface 1106, and/or the processing circuitry 1102 may be configured to perform any receiving operations and/or certain obtaining operations described herein as being performed by the network node. Any information, data and/or signals may be received from a UE, another network node and/or any other network equipment. Similarly, the antenna 1110, the communication interface 1106, and/or the processing circuitry 1102 may be configured to perform any transmitting operations described herein as being performed by the network node. Any information, data and/or signals may be transmitted to a UE, another network node and/or any other network equipment.

The power source 1108 provides power to the various components of network node 1100 in a form suitable for the respective components (e.g. at a voltage and current level needed for each respective component). The power source 1108 may further comprise, or be coupled to, power management circuitry to supply the components of the network node 1100 with power for performing the functionality described herein. For example, the network node 1100 may be connectable to an external power source (e.g. the power grid, an electricity outlet) via an input circuitry or interface such as an electrical cable, whereby the external power source supplies power to power circuitry of the power source 1108. As a further example, the power source 1108 may comprise a source of power in the form of a battery or battery pack which is connected to, or integrated in, power circuitry. The battery may provide backup power should the external power source fail.

Embodiments of the network node 1100 may include additional components beyond those shown in FIG. 11 for providing certain aspects of the network node's functionality, including any of the functionality described herein and/or any functionality necessary to support the subject matter described herein. For example, the network node 1100 may include user interface equipment to allow input of information into the network node 1100 and to allow output of information from the network node 1100. This may allow a user to perform diagnostic, maintenance, repair, and other administrative functions for the network node 1100.

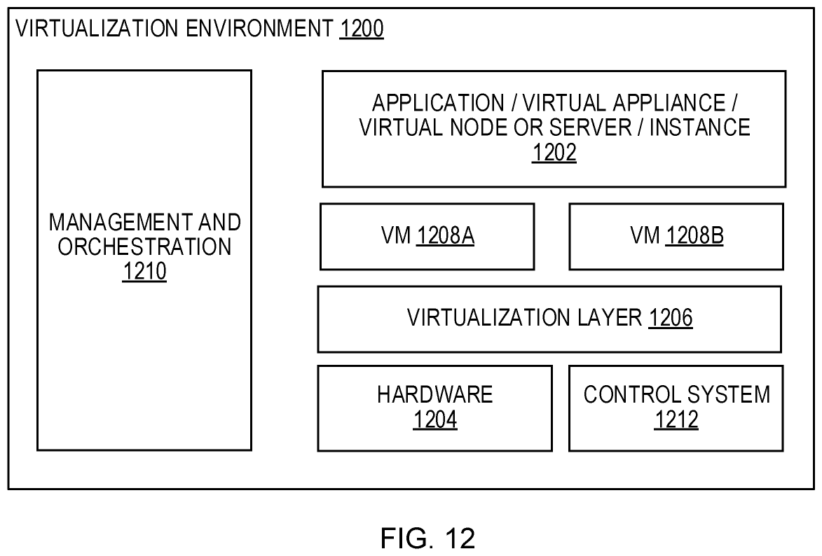

FIG. 12 is a block diagram illustrating a virtualization environment 1200 in which functions implemented by some embodiments may be virtualized.

In the present context, virtualizing means creating virtual versions of apparatuses or devices which may include virtualizing hardware platforms, storage devices and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more virtual machines (VMs) implemented in one or more virtual environments 1200 hosted by one or more of hardware nodes, such as a hardware computing device that operates as an access network node, a wireless device/UE, or a core network node. Further, in embodiments in which the virtual node does not require radio connectivity (e.g. a core network node), then the node may be entirely virtualized.

Applications 1202 (which may alternatively be called software instances, virtual appliances, network functions, virtual nodes, virtual network functions, etc.) are run in the virtualization environment 1200 to implement some of the features, functions, and/or benefits of some of the embodiments disclosed herein.

Hardware 1204 includes processing circuitry, memory that stores software and/or instructions executable by hardware processing circuitry, and/or other hardware devices as described herein, such as a network interface, input/output interface, and so forth. Software may be executed by the processing circuitry to instantiate one or more virtualization layers 1206 (also referred to as hypervisors or virtual machine monitors (VMMs), provide VMs 1208a and 1208b (one or more of which may be generally referred to as VMs 1208), and/or perform any of the functions, features and/or benefits described in relation with some embodiments described herein. The virtualization layer 1206 may present a virtual operating platform that appears like networking hardware to the VMs 1208.

The VMs 1208 comprise virtual processing, virtual memory, virtual networking or interface and virtual storage, and may be run by a corresponding virtualization layer 1206. Different embodiments of the instance of a virtual appliance 1202 may be implemented on one or more of VMs 1208, and the implementations may be made in different ways. Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, a VM 1208 may be a software implementation of a physical machine that runs programs as if they were executing on a physical, non-virtualized machine. Each of the VMs 1208, and that part of hardware 1204 that executes that VM, be it hardware dedicated to that VM and/or hardware shared by that VM with others of the VMs, forms separate virtual network elements. Still in the context of NFV, a virtual network function is responsible for handling specific network functions that run in one or more VMs 1208 on top of the hardware 1204 and corresponds to the application 1202.

Hardware 1204 may be implemented in a standalone network node with generic or specific components. Hardware 1204 may implement some functions via virtualization. Alternatively, hardware 1204 may be part of a larger cluster of hardware (e.g. such as in a data center or CPE) where many hardware nodes work together and are managed via management and orchestration 1210, which, among others, oversees lifecycle management of applications 1202. In some embodiments, hardware 1204 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a radio access node or a base station. In some embodiments, some signalling can be provided with the use of a control system 1212 which may alternatively be used for communication between hardware nodes and radio units.

Although the computing devices described herein (e.g. UEs, network nodes, etc.) may include the illustrated combination of hardware components, other embodiments may comprise computing devices with different combinations of components. It is to be understood that these computing devices may comprise any suitable combination of hardware and/or software needed to perform the tasks, features, functions and methods disclosed herein. Determining, calculating, obtaining or similar operations described herein may be performed by processing circuitry, which may process information by, for example, converting the obtained information into other information, comparing the obtained information or converted information to information stored in the network node, and/or performing one or more operations based on the obtained information or converted information, and as a result of said processing making a determination. Moreover, while components are depicted as single boxes located within a larger box, or nested within multiple boxes, in practice, computing devices may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware. In certain embodiments, some or all of the functionality described herein may be provided by processing circuitry executing instructions stored on in memory, which in certain embodiments may be a computer program product in the form of a non-transitory computer-readable storage medium. In alternative embodiments, some or all of the functionality may be provided by the processing circuitry without executing instructions stored on a separate or discrete device-readable storage medium, such as in a hard-wired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device, but are enjoyed by the computing device as a whole, and/or by end users and a wireless network generally.

The foregoing merely illustrates the principles of the disclosure. Various modifications and alterations to the described embodiments will be apparent to those skilled in the art in view of the teachings herein. It will thus be appreciated that those skilled in the art will be able to devise numerous systems, arrangements, and procedures that, although not explicitly shown or described herein, embody the principles of the disclosure and can be thus within the scope of the disclosure. Various exemplary embodiments can be used together with one another, as well as interchangeably therewith, as should be understood by those having ordinary skill in the art.

### Embodiments

### Group A Embodiments

1. A method performed by a user equipment, UE, the method comprising:
receiving, from a network node, first assistance data for a first Global Navigation Satellite System, GNSS, wherein the first assistance data comprises tropospheric delay correction data; and
receiving, from the network node, second assistance data for a second GNSS, wherein the second assistance data does not include tropospheric delay correction data.
2. The method of embodiment 1, wherein the method further comprises:
determining the position of the UE using measurements of signals from the first GNSS and/or the second GNSS, and using the tropospheric delay correction data received in the first assistance data.
3. The method of embodiment 1 or 2, wherein the first assistance data and the second assistance data are received in a same set of assistance data.
4. The method of embodiment 1 or 2, wherein the second assistance data is received separately from the first assistance data.
5. The method of any of embodiments 1-4, wherein the second assistance data is received within a predetermined time period of the receipt of the first assistance data.
6. The method of any of embodiments 1-5, wherein the method further comprises:
starting a timer when the first assistance data is received; or
monitoring a time since the first assistance data is received.
7. The method of embodiment 6, wherein the UE does not expect to receive tropospheric delay correction data from the network node while the timer is running or until a predetermined period of time has passed since the first assistance data was received.
8. The method of embodiment 6 or 7, wherein the tropospheric delay correction data is used with signals received from any GNSS while the timer is running or until a predetermined period of time has passed since the first assistance data was received.
9. The method of any of embodiments 1-8, wherein the tropospheric delay correction data is valid for use with signals received from any GNSS.
10. The method of any of embodiments 1-9, wherein the tropospheric delay correction data is used with signals received from any GNSS.
11. The method of any of embodiments 1-10, wherein the method further comprises:
receiving, from the network node, an indication that the tropospheric delay correction data is valid for use with signals received from any GNSS.
12. The method of embodiment 11, wherein the indication is received with the first assistance data.
13. The method of any of embodiments 1-12, wherein the method further comprises:
analysing the presence and/or availability of tropospheric delay correction data in the received first assistance data.
14. The method of any of embodiments 1-13, wherein the method further comprises:
sending a request for assistance data to the network node.
15. The method of embodiment 14, wherein the request also requests tropospheric delay correction data.
16. the method of any of embodiments 1-15, wherein the first GNSS and the second GNSS are different GNSS constellations.
17. The method of any of embodiments 1-16, wherein the first GNSS is a first one of GPS, Galileo, GLONASS, BeiDou and QZSS, and the second GNSS is a different one of GPS, Galileo, GLONASS, BeiDou and QZSS.
18. The method of any of embodiments 1-17, wherein the network node is a Location Server, or a Location Management Function.

### Group B Embodiments

19. A method performed by a network node, the method comprising:
sending, to a user equipment, UE, first assistance data for a first Global Navigation Satellite System, GNSS, wherein the first assistance data comprises tropospheric delay correction data; and
sending, to the UE, second assistance data for a second GNSS, wherein the second assistance data does not include tropospheric delay correction data.
20. The method of embodiment 19, wherein the UE is to determine the position of the UE using measurements of signals from the first GNSS and/or the second GNSS, and using the tropospheric delay correction data received in the first assistance data.
21. The method of embodiment 19 or 20, wherein the first assistance data and the second assistance data are sent in a same set of assistance data.
22. The method of embodiment 19 or 20, wherein the second assistance data is sent to the UE separately from the first assistance data.
23. The method of any of embodiments 19-22, wherein the second assistance data is sent within a predetermined time period of the sending of the first assistance data.
24. The method of any of embodiments 19-23, wherein the method further comprises:
starting a timer when the first assistance data is sent; or monitoring a time since the first assistance data is sent.
25. The method of embodiment 24, wherein the network node does not send tropospheric delay correction data to the UE while the timer is running or until a predetermined period of time has passed since the first assistance data was sent.
26. The method of embodiment 24 or 25, wherein the tropospheric delay correction data is to be used by the UE with signals received from any GNSS while the timer is running or until a predetermined period of time has passed since the first assistance data was sent.
27. The method of any of embodiments 19-26, wherein the tropospheric delay correction data is valid for use with signals received from any GNSS.
28. The method of any of embodiments 19-26, wherein the tropospheric delay correction data is to be used with signals received from any GNSS.
29. The method of any of embodiments 19-28, wherein the method further comprises:
sending, to the UE, an indication that the tropospheric delay correction data is valid for use with signals received from any GNSS.
30. The method of embodiment 29, wherein the indication is sent with the first assistance data.
31. The method of any of embodiments 19-30, wherein the method further comprises:
determining an assistance data configuration to use for sending assistance data to a UE.
32. The method of embodiment 31, wherein the first assistance data and the second assistance data are sent to the UE in accordance with the determined assistance data configuration.
33. The method of any of embodiments 19-32, wherein the method further comprises:
receiving a request for assistance data from the UE.
34. The method of embodiment 33, wherein the request also requests tropospheric delay correction data.
35. The method of any of embodiments 19-34, wherein the first GNSS and the second GNSS are different GNSS constellations.
36. The method of any of embodiments 19-35, wherein the first GNSS is a first one of GPS, Galileo, GLONASS, BeiDou and QZSS, and the second GNSS is a different one of GPS, Galileo, GLONASS, BeiDou and QZSS.
37. The method of any of embodiments 19-36, wherein the network node is a Location Server, or a Location Management Function.

### Group C Embodiments

38. A computer program product comprising a computer readable medium having computer readable code embodied therein, the computer readable code being configured such that, on execution by a suitable computer or processor, the computer or processor is caused to perform the method of any of the Group A embodiments or the Group B embodiments.
39. A user equipment, UE, configured to perform the method of any of the Group A embodiments.
40. A user equipment, UE, comprising a processor and a memory, said memory containing instructions executable by said processor whereby said UE is operative to perform the method of any of the Group A embodiments.
41. A network node, configured to perform the method of any of the Group B embodiments.
42. A network node comprising a processor and a memory, said memory containing instructions executable by said processor whereby said network node is operative to perform the method of any of the Group B embodiments.
43. A user equipment, UE, comprising:
processing circuitry configured to cause the user equipment to perform any of the steps of any of the Group A embodiments; and
power supply circuitry configured to supply power to the processing circuitry.
44. A network node, the network node comprising:
processing circuitry configured to cause the network node to perform any of the steps of any of the Group B embodiments;
power supply circuitry configured to supply power to the processing circuitry.
45. A user equipment, UE, the UE comprising:
an antenna configured to send and receive wireless signals;
radio front-end circuitry connected to the antenna and to processing circuitry, and configured to condition signals communicated between the antenna and the processing circuitry;
the processing circuitry being configured to perform any of the steps of any of the Group A embodiments;
an input interface connected to the processing circuitry and configured to allow input of information into the UE to be processed by the processing circuitry;
an output interface connected to the processing circuitry and configured to output information from the UE that has been processed by the processing circuitry; and
a battery connected to the processing circuitry and configured to supply power to the UE.

### APPENDIX

In this Appendix additional information is provided relating to ways in which the techniques described herein can be implemented in the relevant 3GPP standards. In particular, the techniques described herein can be implemented in the 3GPP LPP specifications (3GPP TS 37.355 v17.3.0), which are exemplified below, with proposed changes marked with underlining.

The indication that the AD is only provided for one GNSS constellation and is valid for all GNSS constellations can be encoded in different ways, e.g. in the describing text, via conditional presence, as a field description, etc. These can be considered separately or combined in the specification.

### GNSS-SSR-GriddedCorrection

The IE GNSS-SSR-GriddedCorrection is used by the location server to provide troposphere delay correction, together with the residual part of the STEC corrections and integrity information.

The parameters provided in IE GNSS-SSR-GriddedCorrection-except for SSR-GriddedCorrectionIntegrityParameters and TropoDelayIntegrityErrorBounds—are used as specified for Compact

SSR Gridded Correction Message (e.g., message type 4073,9) in and apply to all GNSSs, where the troposphere delay correction is provided for one GNSS and valid for all other GNSSs.

```
  -- ASN1START
  GNSS-SSR-GriddedCorrection-r16 ::= SEQUENCE {
```

| epochTime-r16 | GNSS-SystemTime, | |
|---|---|---|
| ssrUpdateInterval-r16 | INTEGER (0..15), | |
| iod-ssr-r16 | INTEGER (0..15), | |
| troposphericDelayQualityIndicator-r16 | BIT STRING (SIZE(6)) | OPTIONAL, -- Cond |

Tropo

| | |
|---|---|
| correctionPointSetID-r16 | INTEGER (0..16383), |
| gridList-r16 | GridList-r16, |

```
    ...,
    [[
    ssr-GriddedCorrectionIntegrityParameters-r17
```

SSR-GriddedCorrectionIntegrityParameters-r17

OPTIONAL -- Need OR

```
    ]]
  }
  GridList-r16 ::= SEQUENCE (SIZE(1..64)) OF GridElement-r16
  GridElement-r16 ::= SEQUENCE {
```

| | |
|---|---|
| tropospericDelayCorrection-r16 TropospericDelayCorrection-r16 | OPTIONAL, -- Cond |

NotProvidedForOther

| | |
|---|---|
| stec-ResidualSatList-r16 STEC-ResidualSatList-r16 | OPTIONAL, -- Need ON |

```
    ...
  }
  TropospericDelayCorrection-r16 ::= SEQUENCE {
```

| | |
|---|---|
| tropoHydroStaticVerticalDelay-r16 | INTEGER (−256..255), |
| tropoWetVerticalDelay-r16 | INTEGER (−128..127), |

```
    ...,
    [[
```

| | |
|---|---|
| tropoDelayIntegrityErrorBounds-r17 | TropoDelayIntegrityErrorBounds-r17 |

OPTIONAL -- Cond Integrity1

```
    ]]
  }
  STEC-ResidualSatList-r16 ::= SEQUENCE (SIZE(1..64)) OF STEC-ResidualSatElement-r16
  STEC-ResidualSatElement-r16 ::= SEQUENCE {
      svID-r16 SV-ID,
      stecResidualCorrection-r16 CHOICE {
                    b7-r16 INTEGER (−64..63),
                    b16-r16 INTEGER (−32768..32767)
      },
      ...
}
SSR-GriddedCorrectionIntegrityParameters-r17 ::= SEQUENCE {
```

| probOnsetTroposphereFault-r17 | INTEGER (0..255), | |
|---|---|---|
| meanTroposphereFaultDuration-r17 | INTEGER (1..256), | |
| troposphereRangeErrorCorrelationTime-r17 | INTEGER (1..255) | OPTIONAL, -- Need OR |
| troposphereRangeRateErrorCorrelationTime-r17 | INTEGER (1..255) | OPTIONAL, -- Cond |

Integrity2
...
}
TropoDelayIntegrityErrorBounds-r17 ::= SEQUENCE {

| | |
|---|---|
| meanTroposphereVerticalHydroStaticDelay-r17 | INTEGER (0..255), |
| stdDevTroposphereVerticalHydroStaticDelay-r17 | INTEGER (0..255), |
| meanTroposphereVerticalWetDelay-r17 | INTEGER (0..255), |
| stdDevTroposphereVerticalWetDelay-r17 | INTEGER (0..255), |
| meanTroposphereVerticalHydroStaticDelayRate-r17 | INTEGER (0..255), |
| stdDevTroposphereVerticalHydroStaticDelayRate-r17 | INTEGER (0..255), |
| meanTroposphereVerticalWetDelayRate-r17 | INTEGER (0..255), |
| stdDevTroposphereVerticalWetDelayRate-r17 | INTEGER (0..255), |

...
}
-- ASN1STOP

| Conditional presence | Explanation |
|---|---|
| Tropo | The field is mandatory present if tropospericDelayCorrection is included in gridList. |
| | Otherwise it is not present. |
| NotProvidedForOther | This field is not present if the tropospericDelayCorrection is provided for another GNSS in |
| | the same epoch |
| Integrity1 | The field is mandatory present if SSR-GriddedCorrectionIntegrityParameters is present; |
| | otherwise it is not present. |
| Integrity2 | The field is mandatory present if troposphereRangeErrorCorrelation Time is present; |
| | otherwise it is not present. |

GNSS-SSR-GriddedCorrection field descriptions
epochTime
This field specifies the epoch time of the gridded correction data. The gnss-TimeID in GNSS-System Time shall be the
same as the GNSS-ID in IE GNSS-GenericAssistDataElement.
ssrUpdateInterval
This field specifies the SSR Update Interval. The SSR Update Intervals for all SSR parameters start at time 00:00:00
of the GPS time scale. A change of the SSR Update Interval during the transmission of SSR data should ensure
consistent data for a target device. See table Value of ssrUpdateInterval to SSR Update Interval relation in IE
GNSS-SSR-OrbitCorrections.
iod-ssr
This field specifies the Issue of Data number for the SSR data. A change of iod-ssr is used to indicate a change in the
SSR generating configuration.
troposphericDelayQualityIndicator
This field specifies the quality indicator of the tropospheric delay. The troposphere quality indicator is represented by a
combination of CLASS and VALUE. The 3 MSB define the CLASS with a range of 0-7 and the 3 LSB define the
VALUE with a range of 0-7. The troposphere quality indicator is computed by:
$SSR Tropospher e Quality [ mm ] \leq {3}^{CLASS} ( 1 + \frac{VALUE}{4} ) - 1 [ mm ]$
See Table ′Relationship between SSR troposphere quality and URA indicator and physical quantity′ below
correctionPointSetID
This field provides the ID of the GNSS-SSR-CorrectionPoints set. The GNSS-SSR-GriddedCorrection are valid for the
correction points provided in IE GNSS-SSR-CorrectionPoints with the same correctionPointSetID.
gridList
This field provides the troposphere delay correction together with the residual part of the STEC corrections for up to
64 correction points defined in IE GNSS-SSR-CorrectionPoints.
If the IE GNSS-SSR-CorrectionPoints, which belongs to the correctionPointSetID, includes the listOfCorrectionPoints,
the gridList includes the same number of entries, and listed in the same order, as in the listOfCorrectionPoints.
If the IE GNSS-SSR-CorrectionPoints, which belongs to this correctionPointSetID, includes the
arrayOfCorrectionPoints the gridList includes the same number of entries, and listed in the same order, as defined by
the enabled bits in the bitmaskOfGrids.
tropospericDelayCorrection
This field specifies information element with the troposphere vertical delay components. It is only provided with at
most one GNSS constellation, and if provided it is valid for all GNSS constellations. If it is provided with a different
GNSS constellation the field is not provided with other GNSS constellations for the same epoch.
tropoHydroStaticVerticalDelay
This field specifies the variation in the hydro static troposphere vertical delay relative to nominal value. The target
device should add the constant nominal value of 2.3 m to calculate the tropospheric hydro-static vertical delay.
Scale factor 0.004 m; range ±1.02 m.
tropoWetVerticalDelay
This field specifies the variation in the wet troposphere vertical delay relative to nominal value. The target device
should add the constant value of 0.252 m to calculate the tropospheric wet (non hydro-static) vertical delay.
Scale factor 0.004 m; range ±0.508 m.
svID
This field specifies the GNSS satellite for which the STEC residual corrections are provided.
stecResidualCorrection
This field specifies the STEC residual correction.
Scale factor 0.04 TECU; range ±2.52 TECU (b7) or ±1310.68 TECU (b16).
probOnsetTroposphereFault
This field specifies the Probability of Onset of Troposphere Fault per Time Unit which is the probability of occurrence
of troposphere error to exceed the residual error bound for more than the Time to Alert (TTA) This field specifies the
onset probability that the residual range or range rate error exceeds a bound created using the minimum allowed
inflation factor Kₘᵢₙ, and bounding parameters as mean + Kₘᵢₙ * stdDev where Kₘᵢₙ = normInv(irMaximum / 2) and
irMaximum as provided in IE GNSS-Integrity-ServiceParameters.
The probability is calculated by P = 10^{-0.04n} [hour⁻¹] where n is the value of probOnsetTroposphereFault and the
range is 10^{-10.2} to 1 per hour.
meanTroposphereFaultDuration
This field specifies the Mean Troposphere Fault Duration which is the mean duration between when a troposphere
integrity violation occurs, and the user is alerted through GNSS-Integrity-ServiceAlert (or the integrity violation is over).
Scale factor 1 s; range 1-256 s.
GNSS-SSR-GriddedCorrection field descriptions
troposphereRangeErrorCorrelationTime
This field specifies the Troposphere Range Error Correlation Time which is the upper bound of the correlation time of
the troposphere residual range error.
The time is calculated using:
$t = \{ \begin{matrix}10 i , & i \leq 180 \\ 1800 + 100 ( i - 180 ) , & 180 < i \leq 234 \\ 7200 + 1000 ( i - 234 ) , & i > 234\end{matrix} [ s ]$
Range is 1-28,200 s
troposphereRangeRateErrorCorrelationTime
This field specifies the Troposphere Range Rate Error Correlation Time which is the upper bound of the correlation
time of the troposphere residual range rate error.
The time is calculated using:
$t = \{ \begin{matrix}10 i , & i \leq 180 \\ 1800 + 100 ( i - 180 ) , & 180 \leq i \leq 234 \\ 7200 + 1000 ( i - 234 ) , & i > 234\end{matrix} [ s ]$
Range is 1-28,200 s.
meanTroposphereVerticalHydroStaticDelay
This field specifies the Mean Troposphere Vertical Hydro Static Delay Error bound which is the mean value for an
overbounding model that bounds the residual troposphere error in the vertical hydro static delay component.
The bound is mean Troposphere VerticalHydroStaticDelay + K * stdDevTroposphereVerticalHydroStaticDelay and
shall be so that the probability of it to be exceeded shall be lower than IRallocation for irMinimum < IRallocation <
irMaximum, where K = normInv(IRallocation / 2) and irMinimum, irMaximum as provided in IE GNSS-Integrity-
ServiceParameters.
This IRallocation is a fraction of the Target Integrity Risk that represents the integrity risk budget available.
Scale factor 0.005 m; range 0-1.275 m.
stdDevTroposphereVerticalHydroStaticDelay
This field specifies the Standard Deviation Troposphere Vertical Hydro Static Delay Error bound which is the standard
deviation for an overbounding model that bounds the residual troposphere error in the vertical hydro static delay
component.
Scale factor 0.005 m; range 0-1.275 m.
meanTroposphereVerticalWetDelay
This field specifies the Mean Troposphere Vertical Wet Static Delay Error bound which is the mean value for an
overbounding model that bounds the residual troposphere error in the vertical wet delay component.
The bound is mean Troposphere VerticalWetDelay + K * stdDevTroposphereVerticalWetDelay and shall be so that the
probability of it to be exceeded shall be lower than IRallocation for irMinimum < IRallocation < irMaximum, where
K = normInv(IRallocation / 2) and irMinimum, irMaximum as provided in IE GNSS-Integrity-ServiceParameters.
This IRallocation is a fraction of the Target Integrity Risk that represents the integrity risk budget available.
Scale factor 0.005 m; range 0-1.275 m.
stdDevTroposphereVerticalWetDelay
This field specifies the Standard Deviation Troposphere Vertical Wet Static Delay Error bound which is the standard
deviation for an overbounding model that bounds the residual troposphere error in the vertical wet delay component.
Scale factor 0.005 m; range 0-1.275 m.
meanTroposphereVerticalHydroStaticDelayRate
This field specifies the Mean Troposphere Vertical Hydro Static Delay Rate Error bound which is the mean value for
an overbounding model that bounds the residual troposphere rate error in the vertical hydro static delay component.
The bound is meanTroposphereVerticalHydroStaticDelayRate + K * stdDevTroposphereVerticalHydroStaticDelayRate
and shall be so that the probability of it to be exceeded shall be lower than IRallocation for irMinimum < IRallocation <
irMaximum, where K = normInv(IRallocation / 2) and irMinimum, irMaximum as provided in IE GNSS-Integrity-
ServiceParameters.
This IRallocation is a fraction of the Target Integrity Risk that represents the integrity risk budget available.
Scale factor 0.00005 m/s; range 0-0.01275 m/s.
stdDevTroposphereVerticalHydroStaticDelayRate
This field specifies the Standard Deviation Troposphere Vertical Hydro Static Delay Rate Error bound which is the
standard deviation for an overbounding model that bounds the residual troposphere rate error in the vertical hydro
static delay component.
Scale factor 0.00005 m/s; range 0-0.01275 m/s.
GNSS-SSR-GriddedCorrection field descriptions
meanTroposphereVerticalWetDelayRate
This field specifies the Mean Troposphere Vertical Wet Static Delay Rate Error bound which is the mean value for an
overbounding model that bounds the residual troposphere rate error in the vertical wet delay component.
The bound is mean Troposphere VerticalWetDelayRate + K * stdDevTroposphere VerticalWetDelayRate and shall be so
that the probability of it to be exceeded shall be lower than IRallocation for irMinimum < IRallocation < irMaximum,
where K = normInv(IRallocation / 2) and irMinimum, irMaximum as provided in IE GNSS-Integrity-ServiceParameters.
This IRallocation is a fraction of the Target Integrity Risk that represents the integrity risk budget available.
Scale factor 0.00005 m/s; range 0-0.01275 m/s.
stdDevTroposphereVerticalWetDelayRate
This field specifies the Standard Deviation Troposphere Vertical Wet Static Delay Rate Error bound which is the
standard deviation for an overbounding model that bounds the residual troposphere rate error in the vertical wet delay
component.
Scale factor 0.00005 m/s; range 0-0.01275 m/s.

### Relationship Between SSR Troposphere Quality and URA Indicator and Physical Quantity

| | | | SSR troposphere quality indicator |
|---|---|---|---|
| CLASS | VALUE | Index | and SSR URA Q [mm] |
| 7 | 7 | 63 | 5466.50 < Q |
| 7 | 6 | 62 | 4919.75 < Q ≤ 5466.50 |
| 7 | 5 | 61 | 4373.75 < Q ≤ 4919.75 |
| 7 | 4 | 60 | 3826.25 < Q ≤ 4373.00 |
| 7 | 3 | 59 | 3279.50 < Q ≤ 3826.25 |
| 7 | 2 | 58 | 2732.75 < Q ≤ 3279.50 |
| 7 | 1 | 57 | 2186.00 < Q ≤ 2732.75 |
| 7 | 0 | 56 | 2003.75 < Q ≤ 2186.00 |
| 6 | 7 | 55 | 1821.50 < Q ≤ 2003.75 |
| 6 | 6 | 54 | 1639.25 < Q ≤ 1821.50 |
| 6 | 5 | 53 | 1457.00 < Q ≤ 1639.25 |
| 6 | 4 | 52 | 1274.75 < Q ≤ 1457.00 |
| 6 | 3 | 51 | 1092.50 < Q ≤ 1274.75 |
| 6 | 2 | 50 | 910.25 < Q ≤ 1092.50 |
| 6 | 1 | 49 | 728.00 < Q ≤ 910.25 |
| 6 | 0 | 48 | 667.25 < Q ≤ 728.00 |
| 5 | 7 | 47 | 606.50 < Q ≤ 667.25 |
| 5 | 6 | 46 | 545.75 < Q ≤ 606.50 |
| 5 | 5 | 45 | 485.00 < Q ≤ 545.75 |
| 5 | 4 | 44 | 424.25 < Q ≤ 485.00 |
| 5 | 3 | 43 | 363.50 < Q ≤ 425.25 |
| 5 | 2 | 42 | 302.75 < Q ≤ 363.50 |
| 5 | 1 | 41 | 242.00 < Q ≤ 302.75 |
| 5 | 0 | 40 | 221.75 < Q ≤ 242.00 |
| 4 | 7 | 39 | 201.50 < Q ≤ 221.75 |
| 4 | 6 | 38 | 181.25 < Q ≤ 201.50 |
| 4 | 5 | 37 | 161.00 < Q ≤ 181.25 |
| 4 | 4 | 36 | 140.75 < Q ≤ 161.00 |
| 4 | 3 | 35 | 120.50 < Q ≤ 140.75 |
| 4 | 2 | 34 | 100.25 < Q ≤ 120.50 |
| 4 | 1 | 33 | 80.00 < Q ≤ 100.25 |
| 4 | 0 | 32 | 73.25 < Q ≤ 80.00 |
| 3 | 7 | 31 | 66.50 < Q ≤ 73.25 |
| 3 | 6 | 30 | 59.75 < Q ≤ 66.50 |
| 3 | 5 | 29 | 53.00 < Q ≤ 59.75 |
| 3 | 4 | 28 | 46.25 < Q ≤ 53.00 |
| 3 | 3 | 27 | 39.50 < Q ≤ 46.25 |
| 3 | 2 | 26 | 32.75 < Q ≤ 39.50 |
| 3 | 1 | 25 | 26.00 < Q ≤ 32.75 |
| 3 | 0 | 24 | 23.75 < Q ≤ 26.00 |
| 2 | 7 | 23 | 21.50 < Q ≤ 23.75 |
| 2 | 6 | 22 | 19.25 < Q ≤ 21.50 |
| 2 | 5 | 21 | 17.00 < Q ≤ 19.25 |
| 2 | 4 | 20 | 14.75 < Q ≤ 17.00 |
| 2 | 3 | 19 | 12.50 < Q ≤ 14.75 |
| 2 | 2 | 18 | 10.25 < Q ≤ 12.50 |
| 2 | 1 | 17 | 8.00 < Q ≤ 10.25 |
| 2 | 0 | 16 | 7.25 < Q ≤ 8.00 |
| 1 | 7 | 15 | 6.50 < Q ≤ 7.25 |
| 1 | 6 | 14 | 5.75 < Q ≤ 6.50 |
| 1 | 5 | 13 | 5.00 < Q ≤ 5.75 |
| 1 | 4 | 12 | 4.25 < Q ≤ 5.00 |
| 1 | 3 | 11 | 3.50 < Q ≤ 4.25 |
| 1 | 2 | 10 | 2.75 < Q ≤ 3.50 |
| 1 | 1 | 9 | 2.00 < Q ≤ 2.75 |
| 1 | 0 | 8 | 1.75 < Q ≤ 2.00 |
| 0 | 7 | 7 | 1.50 < Q ≤ 1.75 |
| 0 | 6 | 6 | 1.25 < Q ≤ 1.50 |
| 0 | 5 | 5 | 1.00 < Q ≤ 1.25 |
| 0 | 4 | 4 | 0.75 < Q ≤ 1.00 |
| 0 | 3 | 3 | 0.50 < Q ≤ 0.75 |
| 0 | 2 | 2 | 0.25 < Q ≤ 0.50 |
| 0 | 1 | 1 | Q ≤ 0.25 |
| 0 | 0 | 0 | undefined/unknown |

In one specific implementation, the ASN. 1 can be realized as separate new field as below ASN. 1 extension

```
GridElement-r16 ::= SEQUENCE {
  tropospericDelayCorrection-r16 TropospericDelayCorrection-r16 OPTIONAL, -- Need ON
  stec-ResidualSatList-r16 STEC-ResidualSatList-r16 OPTIONAL, -- Need ON
  ...,
  [[
  tropospericDelayCorrection-r17 TropospericDelayCorrection-r17
  OPTIONAL -- Need OP
  ]]
}
```

tropospericDelayCorrection

This field specifies information element with the troposphere vertical delay components. The field is present only once for one GNSS constellation and the UE may assume the same value is applicable when the value is absent for other GNSS constellation.

1-42. (canceled)

43. A method performed by a user equipment (UE), the method comprising:
receiving, from a network node, first assistance data for a first Global Navigation Satellite System (GNSS), wherein the first assistance data comprises tropospheric delay correction data; and
receiving, from the network node, second assistance data for a second GNSS, wherein the second assistance data does not include tropospheric delay correction data.

44. The method of claim 43, wherein the method further comprises:
determining the position of the UE using measurements of signals from the first GNSS and/or the second GNSS, and using the tropospheric delay correction data received in the first assistance data.

45. The method of claim 43, wherein the second assistance data is received within a predetermined time period of the receipt of the first assistance data.

46. The method of claim 43, wherein the method further comprises:
starting a timer when the first assistance data is received; or
monitoring a time since the first assistance data is received.

47. The method of claim 46, wherein the UE does not expect to receive tropospheric delay correction data from the network node while the timer is running or until a predetermined period of time has passed since the first assistance data was received.

48. The method of claim 46, wherein the tropospheric delay correction data is used with signals received from any GNSS while the timer is running or until a predetermined period of time has passed since the first assistance data was received.

49. The method of claim 43, wherein the tropospheric delay correction data is valid for use with signals received from any GNSS.

50. The method of claim 43, wherein the tropospheric delay correction data is used with signals received from any GNSS.

51. The method of claim 43, wherein the method further comprises:
receiving, from the network node, an indication that the tropospheric delay correction data is valid for use with signals received from any GNSS.

52. The method of claim 51, wherein the indication is received with the first assistance data.

53. The method of claim 43, wherein the method further comprises:
analysing the presence and/or availability of tropospheric delay correction data in the received first assistance data.

54. The method of claim 43, wherein the method further comprises:
sending a request for assistance data to the network node.

55. The method of claim 54, wherein the request also requests tropospheric delay correction data.

56. The method of claim 43, wherein the first GNSS and the second GNSS are different GNSS constellations.

57. The method of claim 43, wherein the first GNSS is a first one of GPS, Galileo, GLONASS, BeiDou and QZSS, and the second GNSS is a different one of GPS, Galileo, GLONASS, BeiDou and QZSS.

58. The method of claim 43, wherein the network node is a Location Server, or a Location Management Function.

59. A method performed by a network node, the method comprising:
sending, to a user equipment (UE), first assistance data for a first Global Navigation Satellite System (GNSS), wherein the first assistance data comprises tropospheric delay correction data; and
sending, to the UE, second assistance data for a second GNSS, wherein the second assistance data does not include tropospheric delay correction data.

60. The method of claim 59, wherein the second assistance data is sent within a predetermined time period of the sending of the first assistance data or is sent together with the first assistance data.

61. A user equipment (UE) comprising:
a memory storing computer program instructions; and
a processor configured to execute the computer program instructions, whereby the processor causes the UE to:
receive, from a network node, first assistance data for a first Global Navigation Satellite System (GNSS), wherein the first assistance data comprises tropospheric delay correction data; and
receive, from the network node, second assistance data for a second GNSS, wherein the second assistance data does not include tropospheric delay correction data.

62. A network node comprising:
a memory storing computer program instructions; and
a processor configured to execute the computer program instructions, whereby the processor causes the network node to:
send, to a user equipment (UE), first assistance data for a first Global Navigation Satellite System (GNSS), wherein the first assistance data comprises tropospheric delay correction data; and
send, to the UE, second assistance data for a second GNSS, wherein the second assistance data does not include tropospheric delay correction data.
